(19) United States
(12) Patent Application Publication
(10) Pub. No.: US 2015/0212246 A1
(43) Pub. Date: Jul. 30, 2015

(54) CIRCULARLY POLARIZING PLATE, METHOD FOR MANUFACTURING SAME, AND OPTICAL LAMINATE

(71) Applicant: FUJIFILM Corporation, Tokyo (JP)

(72) Inventors: Shinpei YOSHIDA, Kanagawa (JP); Naoyoshi YAMADA, Kanagawa (JP); Hiroyuki KAIHOKO, Kanagawa (JP); Yusuke FURUKI, Kanagawa (JP)

(73) Assignee: FUJIFILM CORPORATION, Tokyo (JP)

(21) Appl. No.: 14/677,292

(22) Filed: Apr. 2, 2015

Related U.S. Application Data
(63) Continuation of application No. PCT/JP2013/077044, filed on Oct. 4, 2013.

(30) Foreign Application Priority Data
Oct. 4, 2012 (JP) 2012-222572

(51) Int. Cl. G02B 5/30; B05D 5/06

(52) U.S. Cl. CPC G02B 5/3016; G02B 5/3083; G02B 5/3041; B05D 5/06

(57) ABSTRACT

There are provided a circularly polarizing plate which includes an optically anisotropic layer formed by using a discotic liquid crystal compound and an optically anisotropic layer formed by using a rod-like liquid crystal compound, inhibits an alignment defect of the rod-like liquid crystal compound, and has excellent visibility. The circularly polarizing plate has an optical laminate and a polarizing film.

### CROSS-REFERENCE TO RELATED APPLICATIONS

This application is a Continuation of PCT International Application No. PCT/JP2013/077044 filed on Oct. 4, 2013, which claims priority under 35 U.S.C. §119(a) to Japanese Patent Application No. 2012-222572 filed on Oct. 4, 2012. Each of the above application(s) is hereby expressly incorporated by reference, in its entirety, into the present application.

### BACKGROUND OF THE INVENTION

The present invention relates to a circularly polarizing plate, a method for manufacturing the same, and an optical laminate.

Conventionally, in order to inhibit negative influences resulting from the reflection of external light, a circularly polarizing plate has been used for an EL display apparatus, an LCD display apparatus, and the like.

For example, JP 2005-84277 A discloses a circularly polarizing plate in the form of a combination of a phase difference plate, which includes an optically anisotropic layer, and a linear polarizing film (a polarizing film). More specifically, as the optically anisotropic layer, a laminate is used in which optically anisotropic layers A and B constituted with rod-like liquid crystal compounds are laminated on each other.

### SUMMARY OF THE INVENTION

Meanwhile, in recent years, in view of better viewing angle characteristics, discotic liquid crystal compounds have been preferably used as the liquid crystal compounds constituting the optically anisotropic layers.

With reference to JP 2005-84277 A, the present inventors manufactured an optically anisotropic layer having a laminate structure by using a discotic liquid crystal compound. More specifically, on the optically anisotropic layer formed of the discotic liquid crystal compound, an optically anisotropic layer formed of a rod-like liquid crystal compound was prepared. As a result, the optically anisotropic layer formed of the rod-like liquid crystal compound caused a problem of an alignment defect and a problem of white turbidity.

The present invention has been made under the current circumstances described above, and an object thereof is to provide a circularly polarizing plate which includes an optically anisotropic layer formed by using a discotic liquid crystal compound and an optically anisotropic layer formed by using a rod-like liquid crystal compound, inhibits the alignment defect of the rod-like liquid crystal compound, and has excellent visibility, and to provide a method for manufacturing the circularly polarizing plate.

Another object of the present invention is to provide an optical laminate that can be used for the circularly polarizing plate.

Regarding the problems of the conventional techniques, the present inventors conducted intensive examination. As a result, they found that the aforementioned problems can be solved by controlling the amount of ultraviolet rays radiated for fixing the discotic liquid crystal compound containing a polymerizable group by performing UV irradiation processing on the compound.

That is, they found that the aforementioned objects can be achieved by the following constitution.

[1] A circularly polarizing plate comprising an optical laminate and a polarizing film, in which the optical laminate has a transparent support, an optically anisotropic layer A, and an optically anisotropic layer B that are laminated on each other in this order; the optically anisotropic layer A is formed of a composition containing a discotic liquid crystal compound having a polymerizable group; the optically anisotropic layer B is formed of a composition containing a rod-like liquid crystal compound having a polymerizable group; ReA (450), ReA (550), and ReA (650) which are values of retardation of the optically anisotropic layer A measured at wavelengths of 450 nm, 550 nm, and 650 nm, and ReB (450), ReB (550), and ReB (650) which are values of retardation of the optically anisotropic layer B measured at wavelengths of 450 nm, 550 nm, and 650 nm satisfy the following Expression (1); when ReB (550)>ReA (550), Expression (2) is satisfied; when ReA (550)>ReB (550), Expression (3) is satisfied; and a haze value X of the optical laminate satisfies the following Expression (4).

100 nm≦|ReB(550)−ReA(550)|≦180 nm Expression (1)

ReB(450)/ReB(650)<ReA(450)/ReA(650) Expression (2)

ReA(450)/ReA(650)<ReB(450)/ReB(650) Expression (3)

X<0.50% Expression (4)

[2] The circularly polarizing plate described in [1], in which an angle formed between either the slow axis of the optically anisotropic layer A or the slow axis of the optically anisotropic layer B and the absorption axis of the polarizing film is 45°, and the slow axis of the optically anisotropic layer A is orthogonal to the slow axis of the optically anisotropic layer B.

[3] A method for manufacturing the circular polarizing plate described in [1] or [2], comprising at least a step of forming the optically anisotropic layer A by performing ultraviolet irradiation processing on the discotic liquid crystal compound having a polymerizable group, in which an irradiation amount of the ultraviolet irradiation processing is equal to or greater than 100 mJ/cm² and less than 400 mJ/cm².

[4] An optical laminate comprising a transparent support, an optically anisotropic layer A, and an optically anisotropic layer B that are laminated on each other in this order, in which the optically anisotropic layer A is formed of a composition containing a discotic liquid crystal compound having a polymerizable group; the optically anisotropic layer B is formed of a composition containing a rod-like liquid crystal compound having a polymerizable group; ReA (450), ReA (550), and ReA (650) which are values of retardation of the optically anisotropic layer A measured at wavelengths of 450 nm, 550 nm, and 650 nm, and ReB (450), ReB (550), and ReB (650) which are values of retardation of the optically anisotropic layer B measured at wavelengths of 450 nm, 550 nm, and 650 nm satisfy the following Expression (1); when ReB (550)>ReA (550), Expression (2) is satisfied; when ReA (550)>ReB (550), Expression (3) is satisfied; and a haze value X of the optical laminate satisfies the following Expression (4).

100 nm≦|ReB(550)−ReA(550)|≦180 nm Expression (1)

ReB(450)/ReB(650)<ReA(450)/ReA(650) Expression (2)

ReA(450)/ReA(650)<ReB(450)/ReB(650) Expression (3)

X<0.50% Expression (4)

[5] The optical laminate described in (4), in which the slow axis of the optically anisotropic layer A is orthogonal to the slow axis of the optically anisotropic layer B.

According to the present invention, it is possible to provide a circularly polarizing plate, which includes an optically anisotropic layer formed by using a discotic liquid crystal compound and an optically anisotropic layer formed by using a rod-like liquid crystal compound, inhibits the alignment defect of the rod-like liquid crystal compound, and has excellent visibility, and to provide a method for manufacturing the circularly polarizing plate.

Furthermore, according to the present invention, it is possible to provide an optical laminate that can be used for the circularly polarizing plate.

### BRIEF DESCRIPTION OF THE DRAWINGS

FIG. 1 is a schematic cross-sectional view of a first embodiment of a circularly polarizing plate of the present invention.

FIG. 2 is a schematic cross-sectional view of a second embodiment of the circularly polarizing plate of the present invention.

### DETAILED DESCRIPTION OF THE INVENTION

Hereinafter, the present invention will be described in detail. In the present specification, a range of numerical values that is indicated using “to” means a range in which numerical values before and after “to” are included therein as a lower limit and an upper limit. First, terms used in the present specification will be described.

Re (λ) and Rth (λ) represent in-plane retardation and thickness-direction retardation at a wavelength λ, respectively. By using KOBRA 21ADH or WR (manufactured by Oji Scientific Instruments), Re (λ) is measured by causing light having a wavelength of λ nm to enter a film in the normal line direction of the film. For selecting a measurement wavelength λ nm, wavelength selection filters can be replaced manually, or measured values can be converted by a program to perform the measurement. When a film to be measured can be expressed as a uniaxial or biaxial index ellipsoid, the Rth (λ) is calculated by the following method. The measurement method is partially used for measuring an average tilt angle of the side of an alignment film of rod-like liquid crystal molecules in an optically anisotropic layer B, which will be described later, and for measuring an average tilt angle of the side opposite to the aforementioned side.

For calculating Rth (λ), light having a wavelength of λ nm is caused to enter a film from the directions at every 10° starting from the normal line direction of the film until up to 50° continuously tilted from the normal line direction to one side, while an in-plane slow axis (determined by KOBRA 21ADH or WR) is used as an axis of tilt (axis of rotation) (where there is no slow axis, any in-plane direction of the film is used as the axis of rotation), whereby the Re (λ) is measured at 6 points in total. Based on the value of retardation measured in this manner, a suppositional value of an average refractive index, and an input value of the film thickness, KOBRA 21ADH or WR calculates Rth (λ). In the above method, if the film has a direction in which the value of retardation becomes zero at a certain angle of tilt when the in-plane slow axis in the normal line direction is used as an axis of rotation, the sign of a value of retardation at an angle of tilt that is larger than the above angle of tilt is changed to a minus sign, and then Rth (λ) is calculated by KOBRA 21ADH or WR. It is also possible to measure a value of retardation in two directions that tilt at any angle by using the slow axis as the axis of tilt (axis of rotation) (when there is no slow axis, any in-plane direction of the film is used as the axis of rotation), and to calculate Rth by the following Formulae (A) and (B) based on the value measured as above, a suppositional value of an average refractive index, and an input value of the film thickness.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Equation ( A )$$

Re (θ) in the above formula represents a value of retardation in a direction tilting at an angle θ from the normal line direction. Moreover, nx in Formula (A) represents a refractive index in the direction of an in-plane slow axis, ny represents a refractive index of an in-plane direction orthogonal to nx, and nz represents a refractive index of a direction orthogonal to nx and ny. d represents a thickness of the film to be measured.

Rth=((nx+ny)/2−nz)×d Formula (B)

When the film to be measured is a film which cannot be expressed as a uniaxial or biaxial index ellipsoid, that is, a film without a so-called optical axis, Rth (λ) is calculated by the following method. For calculating Rth (λ), light having a wavelength of λ nm is caused to enter a film from directions tilting from −50° to +50° respectively with respect to the normal line direction of the film at intervals of 10°, of which an in-plane slow axis (determined by KOBRA 21ADH or WR) is used as an axis of tilt (axis of rotation), whereby the Re (λ) is measured at 11 points in total. Based on the value of retardation measured in this manner, a suppositional value of an average refractive index, and an input value of the film thickness, KOBRA 21ADH or WR calculates Rth (λ). In the above measurement, as the suppositional value of an average refractive index, the values described in Polymer Handbook (JOHN WILEY & SONS. INC.) and in catalogs of various optical films can be used. If the value of average refractive index of a film is not known, the value can be measured by the Abbe's refractometer. The values of the average refractive index of main optical films are as follows: cellulose acylate (1.48), cycloolefin polymers (1.52), polycarbonate (1.59), polymethyl methacrylate (1.49), and polystyrene (1.59). When suppositional values of these average refractive indices and the film thickness are input in KOBRA 21ADH or WR, the apparatus calculates nx, ny, and nz. From the calculated nx, ny, and nz, a value Nz is further calculated by Nz=(nx−nz)/(nx−ny).

In the present specification, “visible light” refers to light having a wavelength of 380 nm to 780 nm. Moreover, in the present specification, the measurement wavelength is 550 nm unless otherwise specified.

In addition, in the present specification, the angle (for example, “90°”, and the like) and the angular relationship (for example, “orthogonal”, “parallel”, “45°”, “90°”, “15°”, “75°”, and the like) include a margin of error allowable in the technical field to which the present invention belongs. Specifically, the margin of error is within a range of a precise angle±less than 10°. A difference between the precise angle and the angle in the angular relationship is preferably 5° or less and more preferably 3° or less. That is, “45°” means a range of 45°±less than 10° (a range more than 35° and less than) 55°

### First Embodiment

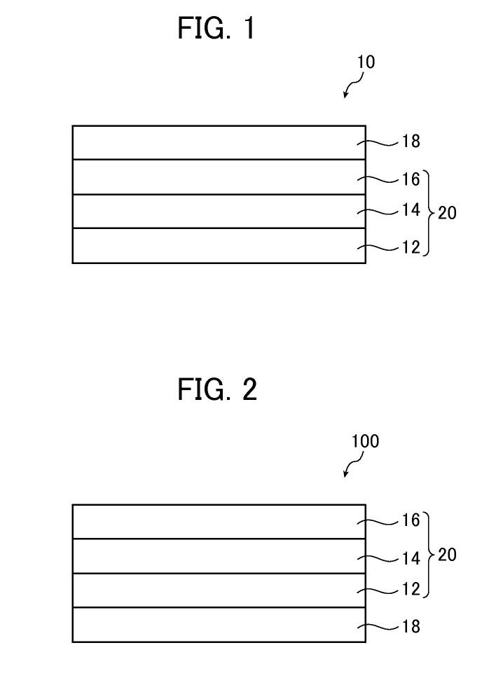

Hereinafter, a first embodiment of a circularly polarizing plate of the present invention will be described with reference to a drawing. FIG. 1 is a schematic cross-sectional view of the first embodiment of the circularly polarizing plate of the present invention.

A circularly polarizing plate 10 includes a transparent support 12, an optically anisotropic layer A14, an optically anisotropic layer B16, and a polarizing film 18 that are laminated on each other in this order. The optically anisotropic layer A14 is formed of a composition containing a discotic liquid crystal compound having a polymerizable group, and the optically anisotropic layer B16 is formed of a composition containing a rod-like liquid crystal compound having a polymerizable group. The transparent support 12, the optically anisotropic layer A14, and the optically anisotropic layer B16 constitute an optical laminate 20.

Hereinafter, each of the members will be specifically described.

<Transparent Support>

The transparent support is a substrate supporting the optically anisotropic layer A, the optically anisotropic layer B, and the like, which will be described later.

As materials for forming the transparent support, polymers having excellent optical transparency, mechanical strength, thermal stability, moisture shielding properties, isotropy, and the like are preferable. The word “transparent” in the present invention means that a visible light transmittance of the support is 60% or higher. The visible light transmittance is preferably 80% or higher and particularly preferably 90% or higher.

Examples of materials forming the transparent support include polycarbonate-based polymers; polyester-based polymers such as polyethylene terephthalate and polyethylene naphthalate; acryl-based polymers such as polymethyl (meth)acrylate; and styrene-based polymers such as polystyrene and an acrylonitrile/styrene copolymer (AS resin). Examples of materials forming the transparent support also include polyolefin-based polymers such as polyethylene, polypropylene, and an ethylene/propylene copolymer; vinyl chloride-based polymers; amide-based polymers such as nylon and aromatic polyamide; imide-based polymers; sulfone-based polymers; polyethersulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers together.

Moreover, as materials for forming the transparent support, thermoplastic norbornene-based resins can be preferably used. Examples of the thermoplastic norbornene-based resins include Zeonex and Zeonor manufactured by ZEON CORPORATION, Arton manufactured by JSR Corporation, and the like.

Furthermore, as materials for forming the transparent support, cellulose-based polymers, which have been conventionally used as transparent protective films of polarizing plates and are represented by triacetyl cellulose, can be preferably used. Among the cellulose-based polymers, cellulose acylate is particularly preferable.

Hereinafter, cellulose acylate will be mainly described in detail as an example of the transparent support.

[Additives for Transparent Support]

Various additives (for example, an optical anisotropy regulator, a wavelength dispersion regulator, fine particles, a plasticizer, an ultraviolet inhibitor, deterioration inhibitor, and a release agent) can be added to the transparent support. These additives will be described below. When the transparent support is a cellulose acylate film, the additives may be added at any stage of a dope preparation step (preparation step of a cellulose acylate solution), and a step of adding the additives may be performed at the final stage of the dope preparation step.

[Ultraviolet Absorber]

The transparent support preferably contains an ultraviolet absorber (a UV absorber). Containing the ultraviolet absorber, the transparent support can absorb ultraviolet rays. If the ultraviolet absorber is contained in the transparent support, it is possible to prevent yellowing of the transparent support that is caused when the transparent support is exposed to ultraviolet rays included in external light (for example, the yellowing is observed as a decrease in transmittance at a wavelength of 400 nm) or to prevent a change in retardation of the optically anisotropic layer A laminated on one surface of the transparent support that is also caused when the transparent support is exposed to ultraviolet rays included in external light (for example, the change in retardation is observed as a Re change). Specific examples of the UV absorber include the compounds described in paragraphs [0059] to [0135] in JP 2006-199855 A.

The transmittance of the transparent support at a wavelength of 380 nm is preferably equal to or less than 50%, more preferably equal to or less than 20%, even more preferably equal to or less than 10%, and particularly preferably equal to or less than 5%.

[Compound Deteriorating Optical Anisotropy]

Specific examples of a compound deteriorating the optical anisotropy of the transparent support include the compounds described in paragraphs [0035] to [0058] in JP 2006-199855 A, but the compound deteriorating the optical anisotropy of the transparent support is not limited to those compounds.

[Plasticizer, Deterioration Inhibitor, and Release Agent]

In addition to the compound deteriorating the optical anisotropy, the UV absorber, and the matting agent, as described above, various additives (for example, a plasticizer, a deterioration inhibitor, a release agent, and an infrared absorber) can be added to the transparent support according to the purpose. The additives may be in the form of a solid or an oily substance. The details of these materials are specifically described on pages 16 to 22 in the journal of technical disclosure of the Japan Institute for Promoting Invention and Innovation (technology publication No. 2001-1745, issued on Mar. 15, 2001, Japan Institute for Promoting Invention and Innovation).

<Optically Anisotropic Layer>

The optically anisotropic layer A and the optically anisotropic layer B are layers disposed on the transparent support, and a phase difference is generated between the layers.

The materials and manufacturing conditions of the optically anisotropic layer A and the optically anisotropic layer B can be selected according to various purposes thereof. However, in one of the preferable embodiments thereof, one of the optically anisotropic layers A and B is a λ/4 film, and the other is a λ/2 film.

A value of retardation of the optically anisotropic layer A at a wavelength of 550 nm (ReA (550)) and a value of retardation of the optically anisotropic layer B at a wavelength of 550 nm (ReB (550)) are regulated to satisfy the following Expression (1).

100 nm≦|ReB(550)−ReA(550)|≦180 nm Expression (1)

|ReB (550)−ReA (550)|, which is an absolute value of a difference between ReA (550) and ReB (550), is preferably 110 nm to 170 nm and more preferably 120 nm to 160 nm, since within the above range, the optically anisotropic layers (the optical laminate) including the optically anisotropic layer A and the optically anisotropic layer B can have a broader wavelength band with respect to anti-reflection performance at the front.

A value of retardation of the optically anisotropic layer A at a wavelength of 450 nm (ReA (450)), a value of retardation of the optically anisotropic layer A at a wavelength of 650 nm (ReA (650)), a value of retardation of the optically anisotropic layer B at a wavelength of 450 nm (ReB (450)), and a value of retardation of the optically anisotropic layer B at a wavelength of 650 nm (ReB (650)) are regulated to satisfy the relationship of the following Expression (2) or Expression (3).

More specifically, when ReB (550)>ReA (550), Expression (2) is satisfied.

ReB(450)/ReB(650)<ReA(450)/ReA(650) Expression (2)

When ReA (550)>ReB (550), Expression (3) is satisfied.

ReA(450)/ReA(650)<ReB(450)/ReB(650) Expression (3)

The angular relationship between the absorption axis of the polarizing film and the optically anisotropic layer A as well as the optically anisotropic layer B is not particularly limited. However, it is preferable that the optically anisotropic layers A and B are disposed such that an angle of 45° is formed between either the slow axis of the optically anisotropic layer A or the slow axis of the optically anisotropic layer B and the absorption axis of the polarizing film, and the slow axis of the optically anisotropic layer A is orthogonal to the slow axis of the optically anisotropic layer B. More specifically, when one of the optically anisotropic layer A and the optically anisotropic layer B is a λ/4 film, and the other is a λ/2 film, it is preferable that an angle of 45° is formed between the slow axis of the optically anisotropic layer as the λ/2 film and the absorption axis of the polarizing film, and the slow axis of the optically anisotropic layer A is orthogonal to the slow axis of the optically anisotropic layer B. For example, in FIG. 1, when the optically anisotropic layer B is a λ/2 film, and the optically anisotropic layer A is a λ/4 film, an embodiment is established in which an angle of 45° is formed between the absorption axis of the polarizing film and the slow axis of the optically anisotropic layer B, and the slow axis of the optically anisotropic layer A is orthogonal to the slow axis of the optically anisotropic layer B.

The axial relationship between the absorption axis of the polarizing film and the slow axis of the optically anisotropic layers A and B is not limited to the aforementioned relationship. For example, in FIG. 1, when the optically anisotropic layer B is a λ/2 film, and the optically anisotropic layer A is a λ/4 film, it is also preferable that an angle of 75° is formed between the absorption axis of the polarizing film and the slow axis of the optically anisotropic layer B, and an angle of 15° is formed between the absorption axis of the polarizing film and the slow axis of the optically anisotropic layer A. In other words, it is preferable that an angle of 15° is formed between the transmission axis of the polarizing film and the slow axis of the optically anisotropic layer B, and an angle of 75° is formed between the transmission axis of the polarizing film and the slow axis of the optically anisotropic layer A.

The λ/4 film (λ/4 plate) is an optically anisotropic layer that is a ¼ wavelength plate for light having at least a wavelength of 550 nm. The λ/4 film preferably satisfies the following Expression (A).

110 nm≦Re(550)≦165 nm Expression (A)

The λ/2 film (λ/2 plate) is an optically anisotropic layer that is a ½ wavelength plate for light having at least a wavelength of 550 nm. The λ/2 film preferably satisfies the following Expression (B).

220 nm≦Re(550)≦325 nm Expression (B)

If the optically anisotropic layer A and the optically anisotropic layer B have the aforementioned optical properties, they can function as a broadband λ/4 plate in the entire wavelength region required. Generally, the region of visible light is deemed to be the wavelength region required. It is desirable that λ/4 can be established even when the wavelength is investigated from the region of visible light to any of wavelength ranges having a wavelength of equal to or greater than 100 nm.

It is preferable that the optically anisotropic layer A and the optically anisotropic layer B are adjacent to each other, and there is substantially no alignment film between the optically anisotropic layer A and the optically anisotropic layer B. In the present specification, the sentence “there is substantially no alignment film” means that a film formed for functioning solely as an alignment film is not included. Even when the surface of the lower layer makes a contribution to the alignment of the liquid crystal compound of the upper layer, only a case in which the use of the formed lower layer is not restricted to the alignment film is included in the present invention.

The surface of the optically anisotropic layer A is not sticky, and even when the surface is rubbed with a cloth, the components in the layer are not transferred to the cloth. Accordingly, the surface of the optically anisotropic layer A can be directly subjected to rubbing processing. Therefore, after the optically anisotropic layer A is formed, if the surface thereof is directly subjected to rubbing processing, and the rubbing-processed surface is coated with a composition containing a rod-like liquid crystal compound having a polymerizable group, the optically anisotropic layer B can be formed. That is, the optically anisotropic layer A and the optically anisotropic layer B may be disposed such that they come into direct contact with each other.

The optically anisotropic layer A is formed of a composition containing a discotic liquid crystal compound having a polymerizable group, and the optically anisotropic layer B is formed of a composition containing a rod-like liquid crystal compound having a polymerizable group. In other words, the optically anisotropic layer A is a layer formed by fixing a discotic liquid crystal compound by polymerization or the like. After being formed into a layer, the optically anisotropic layer A does not need to exhibit liquid crystallinity. The optically anisotropic layer. B is a layer formed by fixing a rod-like liquid crystal compound by polymerization or the like. After being formed into a layer, the optically anisotropic layer B does not need to exhibit liquid crystallinity. More specifically, the optically anisotropic layer A is a layer obtained by applying the composition containing a discotic liquid crystal compound having a polymerizable group and curing the composition by polymerization. The optically anisotropic layer B is a layer obtained by applying the composition containing a rod-like liquid crystal compound having a polymerizable group and curing the composition by polymerization.

Each of the discotic liquid crystal compound and the rod-like liquid crystal compound used may be polyfunctional or monofunctional.

The type of the polymerizable group contained in the discotic liquid crystal compound and the rod-like liquid crystal compound is not particularly limited. The polymerizable group is preferably a functional group that can cause an addition polymerization reaction, and the functional group is preferably an ethylenically unsaturated polymerizable group or a ring-opening polymerizable group. More specifically, preferable examples thereof include a (meth)acryloyl group, a vinyl group, a styryl group, an allyl group, and the like, and among these, a (meth)acryloyl group is more preferable.

In the optically anisotropic layer A and the optically anisotropic layer B, molecules of the liquid crystal compound (the discotic liquid crystal compound or the rod-like liquid crystal compound) are preferably fixed in any of alignment states including vertical alignment, horizontal alignment, hybrid alignment, and inclined alignment. In order to prepare an optical laminate (a phase difference plate) having symmetric viewing angle dependency, either or both of a case in which the surface of the disc of the discotic liquid crystal compound is substantially perpendicular to the surface of the transparent support (the surface direction of the optically anisotropic layer A) and a case in which the major axis of the rod-like liquid crystal compound is substantially parallel to the surface of the transparent support (the surface of the optically anisotropic layer B) are preferable. The state in which the discotic liquid crystal compound is substantially perpendicular to the surface of the transparent support means that the average angle formed between the surface of the transparent support (the surface of the optically anisotropic layer A) and the surface of the disc of the discotic liquid crystal compound is within a range of 70° to 90°. The average angle is preferably 80° to 90°, and more preferably 85° to 90°. The state in which the rod-like liquid crystal compound is substantially parallel to the surface of the transparent support means that the angle formed between the surface of the transparent support (the surface of the optically anisotropic layer B) and the director of the rod-like liquid crystal compound is within a range of 0° to 20°. The angle is more preferably 0° to 10°, and even more preferably 0° to 5°.

When the molecules of the discotic liquid crystal compound or the rod-like liquid crystal compound are aligned in the form of hybrid alignment, the average angle of inclination of the director of the liquid crystal compound is preferably 5° to 85°, more preferably 10° to 80°, and even more preferably 15° to 75°.

Each of the optically anisotropic layer A and the optically anisotropic layer B can be formed by coating the transparent support with a composition (coating liquid) which contains either the discotic liquid crystal compound having a polymerizable group or the rod-like liquid crystal compound having a polymerizable group and contains, as an optional component, a polymerization initiator, an alignment control agent, or other additives that will be described later.

As described later, it is preferable that each of the optically anisotropic layer A and the optically anisotropic layer B is formed by forming an alignment film on the transparent support and coating the surface of the alignment film with the composition (coating liquid).

The content of the discotic liquid crystal compound having a polymerizable group or the rod-like liquid crystal compound having a polymerizable group in the composition used for forming the optically anisotropic layer A or the optically anisotropic layer B is preferably equal to or greater than 50% by mass, more preferably 70% by mass to 99% by mass, and even more preferably 80% by mass to 98% by mass, with respect to the total solid content of the composition (with respect to the composition excluding a solvent, when the composition is used in the form of coating liquid). If the content is within the above range, a sufficient phase difference can be exhibited in a thin film.

The composition used for forming the optically anisotropic layer A and the optically anisotropic layer B may contain an alignment control agent that controls the alignment of liquid crystal. Examples of a usable alignment control agent include an alignment control agent for an alignment film interface that is localized at the side of the alignment film interface and controls the alignment of liquid crystals of the alignment film interface, and an alignment control agent for an air interface that is localized at the side of the air interface and controls the alignment of liquid crystals at the side of the air interface.

Hereinafter, compounds used for forming the optically anisotropic layer A14 and the optically anisotropic layer B16 will be specifically described.

[Discotic Liquid Crystal Compound]

The discotic liquid crystal compound is described in various documents (C. Destrade et al., Mol. Crysr. Liq. Cryst., vol. 71, page 111 (1981); The Chemical Society of Japan, Kikan Kagaku Sosetsu, No. 22, Chemistry of Liquid Crystals, Chapter 5, Section 2 of Chapter 10 (1994); B. Kohne et al., Angew. Chem. Soc. Chem. Comm., page 1794 (1985); J. Zhang et al., J. Am. Chem. Soc., vol. 116, page 2655 (1994)). Moreover, JP 8-27284 A describes the polymerization of the discotic liquid crystal compound.

The discotic liquid crystal compound used has a polymerizable group such that the compound can be fixed by polymerization. For example, it is conceivable that the compound may have a structure in which the polymerizable group as a substituent is bonded to the discotic core of the discotic liquid crystal compound. However, if the polymerizable group is directly bonded to the discotic core, it is difficult to maintain the alignment state during the polymerization reaction. Therefore, a structure having a linking group between the discotic core and the polymerizable group is preferable. That is, the discotic liquid crystal compound having a polymerizable group is preferably a compound represented by the following formula.

D(-L-P)ₙ

In the formula, D is a discotic core, L is a divalent linking group, P is a polymerizable group, and n is an integer of 1 to 12. Specifically, preferable examples of the discotic core (D), the divalent linking group (L), and the polymerizable group (P) in the formula include (D1) to (D15), (L1) to (L25), and (P1) to (P18) respectively that are described in JP 2001-4837 A, and the content described in the same document can be preferably used. A discotic nematic liquid crystal phase-solid phase transition temperature of the liquid crystal compound is preferably 30° C. to 300° C., and more preferably 30° C. to 170° C.

A discotic liquid crystal compound represented by the following Formula (I) exhibits a low degree of wavelength dispersibility of in-plane retardation and can exhibit a high degree of in-plane retardation. Moreover, even if a special alignment film or additives are not used, this compound can be vertically aligned with excellent uniformity at a high level of average angle of inclination. Accordingly, the discotic liquid crystal compound is preferably used for forming the optically anisotropic layer A. Furthermore, the composition containing such a liquid crystal compound is preferable, since the viscosity thereof tends to be relatively low, and the coating properties thereof are excellent.

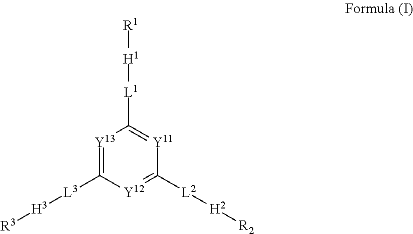

In the formula, each of Y¹¹, Y¹², and Y¹³ independently represents either methine which may be substituted or a nitrogen atom.

When each of Y¹¹, Y¹², and Y¹³ represents methine, a hydrogen atom of the methine may be substituted with a substituent. Examples of a preferable substituent that the methine may have include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among these substituents, an alkyl group, an alkoxy group, an alkoxycarbonyl group, an acyloxy group, a halogen atom, and a cyano group are more preferable, and an alkyl group having 1 to 12 carbon atoms, an alkoxy group having 1 to 12 carbon atoms, an alkoxycarbonyl group having 2 to 12 carbon atoms, an acyloxy group having 2 to 12 carbon atoms, a halogen atom, and a cyano group are even more preferable.

In view of ease of synthesis and cost of the compound, all of Y¹¹, Y¹², and Y¹³ are more preferably methine, and the methine is even more preferably unsubstituted.

Each of L¹, L², and L³ independently represents a single bond or a divalent linking group.

When each of L¹, L², and L³ represents a divalent linking group, each of L¹, L², and L³ is preferably a divalent linking group selected from the group consisting of —O—, —S—, —C(═O)—, —NR⁷—, —CH═CH—, —C≡C—, a divalent cyclic group, and a combination of these. R⁷ is an alkyl group having 1 to 7 carbon atoms or a hydrogen atom. R⁷ is preferably an alkyl group having 1 to 4 carbon atoms or a hydrogen atom, more preferably a methyl group, an ethyl group, or a hydrogen atom, and most preferably a hydrogen atom.

The divalent cyclic group represented by each of L¹, L², and L³ is a divalent linking group having at least one kind of cyclic structure (hereinafter, referred to as a “cyclic group” in some cases). The cyclic group is preferably a 5-membered ring, a 6-membered ring, or a 7-membered ring, more preferably a 5-membered ring or a 6-membered ring, and most preferably a 6-membered ring. The ring contained in the cyclic group may be a condensed ring, but the ring is more preferably a monocyclic ring rather than a condensed ring. The ring contained in the cyclic group may be any of an aromatic ring, an aliphatic ring, and a heterocyclic ring. Preferable examples of the aromatic ring include a benzene ring and a naphthalene ring. Preferable examples of the aliphatic ring include a cyclohexane ring. Preferable examples of the heterocyclic ring include a pyridine ring and a pyrimidine ring. As the cyclic group, an aromatic ring and a heterocyclic ring are more preferable. In the present invention, the divalent cyclic group is more preferably a divalent linking group composed only of a cyclic structure (here, the cyclic structure contains a substituent) (the same will be applied hereinafter).

Among the divalent cyclic groups represented by L¹, L², and L³, as the cyclic group having a benzene ring, a 1,4-phenylene group is preferable. As the cyclic group having a naphthalene ring, a naphthalene-1,5-diyl group and a naphthalene-2,6-diyl group are preferable. As the cyclic group having a cyclohexane ring, a 1,4-cyclohexylene group is preferable. As the cyclic group having a pyridine ring, a pyridine-2,5-diyl group is preferable. As the cyclic group having a pyrimidine ring, a pyrimidine-2,5-diyl group is preferable.

The divalent cyclic groups represented by L¹, L², and L³ may have a substituent. The substituent includes a halogen atom (preferably a fluorine atom and a chlorine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, a carbamoyl group substituted with an alkyl group having 2 to 16 carbon atoms, and an acylamino group having 2 to 16 carbon atoms.

As L¹, L², and L³, a single bond, *—O—CO—, *—CO—O—, *—CH═CH—, *—C≡C—, *-divalent cyclic group-, *—O—CO-divalent cyclic group-, *—CO—O-divalent cyclic group-, *—CH═CH-divalent cyclic group-, *—C≡C-divalent cyclic group-, *-divalent cyclic group-O—CO—, *-divalent cyclic group-CO—O—, *-divalent cyclic group-CH═CH—, and *-divalent cyclic group-C≡C— are preferable. Particularly, a single bond, *—CH═CH—, *—C≡C—, *—CH═CH-divalent cyclic group-, and *—C≡C-divalent cyclic group- are more preferable, and a single bond is most preferable. Herein, “*” represents a position at which each of L¹, L², and L³ is bonded to the side of the 6-membered ring containing Y¹¹, Y¹², and Y¹³ in Formula (I).

In Formula (I), each of H¹, H², and H³ independently represents a group represented by Formula (I-A) or (I-B).

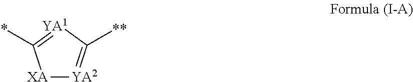

In Formula (I-A), each of YA¹ and YA² independently represents either methane, which may have a substituent, or a nitrogen atom; XA represents an oxygen atom, a sulfur atom, methylene, or imino; “*” represents a position at which each of H¹, H², and H³ is bonded to the side of L¹ to L³ in Formula (I); and “**” represents a position at which each of H¹, H², and H³ is bonded to the side of R¹ to R³ in Formula (I).

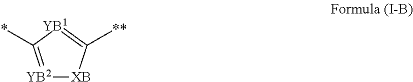

In Formula (I-B), each of YB¹ and YB² independently represents either methane, which may have a substituent, or a nitrogen atom; XB represents an oxygen atom, a sulfur atom, methylene, or imino; “*” represents a position at which each of H¹, H², and H³ is bonded to the side of L¹ to L³ in Formula (I); and “**” represents a position at which each of H¹, H², and H³ is bonded to the side of R¹ to R³ in Formula (I).

In Formula (I), each of R¹, R², and R³ independently represents the following Formula (I-R).

*-(-L²¹-Q²)ₙ₁-L²²-L²³-Q¹ Formula (I-R)

In Formula (I-R), “*” represents a position at which each of R¹, R², and R³ is bonded to the side of H¹ to H³ in Formula (I).

L²¹ represents a single bond or a divalent linking group. When L²¹ is a divalent linking group, L²¹ is preferably a divalent linking group selected from the group consisting of —O—, —S—, —C(═O)—, —NR⁸—, —CH═CH—, —C≡C—, and a combination of these. R⁸ is either an alkyl group having 1 to 7 carbon atoms or a hydrogen atom. R⁸ is preferably either an alkyl group having 1 to 4 carbon atoms or a hydrogen atom, more preferably a methyl group, an ethyl group, or a hydrogen atom, and most preferably a hydrogen atom.

L²¹ is preferably any of a single bond, ***—O—CO—, ***—CO—O—, ***—CH═CH—, and ***—C≡C— (herein, “***” represents the side of “*” in Formula (I-R)), and more preferably a single bond.

Q² represents a divalent group having at least one kind of cyclic structure (cyclic group). As such a cyclic group, a cyclic group having a 5-membered ring, a 6-membered ring, or a 7-membered ring is preferable, a cyclic group having a 5-membered ring or a 6-membered ring is more preferable, and a cyclic group having a 6-membered ring is even more preferable. The cyclic structure contained in the cyclic group may be a condensed ring, but the cyclic structure is preferably a monocyclic ring rather than a condensed ring. The ring contained in the cyclic group may be any of an aromatic ring, an aliphatic ring, and a heterocyclic ring. Preferable examples of the aromatic ring include a benzene ring, a naphthalene ring, an anthracene ring, and a phenanthrene ring. Preferable examples of the aliphatic ring include a cyclohexane ring. Preferable examples of the heterocyclic ring include a pyridine ring and a pyrimidine ring.

As the cyclic group having a benzene ring that is represented by Q², a 1,3-phenylene group and a 1,4-phenylene group are preferable. As the cyclic group having a naphthalene ring, a naphthalene-1,4-diyl group, a naphthalene-1,5-diyl group, a naphthalene-1,6-diyl group, a naphthalene-2,5-diyl group, a naphthalene-2,6-diyl group, and a naphthalene-2,7-diyl group are preferable. As the cyclic group having a cyclohexane ring, a 1,4-cyclohexylene group is preferable. As the cyclic group having a pyridine ring, a pyridine-2,5-diyl group is preferable. As the cyclic group having a pyrimidine ring, a pyrimidine-2,5-diyl group is preferable. Among these, a 1,4-phenylene group, a naphthalene-2,6-diyl group, and a 1,4-cyclohexylene group are particularly preferable.

As the cyclic group having a 5-membered ring that is represented by Q², a 1,2,4-oxadiazole-2,5-diyl group, a 1,3,4-oxadiazole-2,5-diyl group, a 1,2,4-thiadiazole-2,5-diyl group, and a 1,3,4-thiadiazole-2,5-diyl group are preferable.

Q² may have a substituent. Examples of the substituent include a halogen atom (a fluorine atom, a chlorine atom, a bromine atom, or an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, a carbamoyl group substituted with alkyl having 2 to 16 carbon atoms, and an acylamino group having 2 to 16 carbon atoms. Among these, a halogen atom, a cyano group, an alkyl group having 1 to 6 carbon atoms, and a halogen-substituted alkyl group having 1 to 6 carbon atoms are preferable, a halogen atom, an alkyl group having 1 to 4 carbon atoms, and a halogen-substituted alkyl group having 1 to 4 carbon atoms are more preferable, and a halogen atom, an alkyl group having 1 to 3 carbon atoms, and a trifluoromethyl group are even more preferable.

n1 represents an integer of 0 to 4. n1 is preferably an integer of 1 to 3, and more preferably 1 or 2.

L²² represents **—O—, **—O—CO—, **—CO—O—, **—O—CO—O—, **—S—, **—N(R¹⁰¹) **—SO₂—, **—CH₂—, **—CH═CH—, or **—C≡C—. R¹⁰¹ represents an alkyl group having 1 to 5 carbon atoms, and “**” represents a position at which L²² is bonded to the side of Q².

L²² is preferably **—O—, **—O—CO—, **—CO—O—, **—O—CO—O—, **—CH═CH—, or **—CO—, and more preferably **—O—, **—O—CO—, **—O—CO—O—, or **—CH₂—. When L²² is a group containing a hydrogen atom, the hydrogen atom may be substituted with a substituent. Preferable examples of the substituent include a halogen atom, a cyano group, a nitro group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, a carbamoyl group substituted with alkyl having 2 to 6 carbon atoms, and an acylamino group having 2 to 6 carbon atoms. Among these, a halogen atom and an alkyl group having 1 to 6 carbon atoms are more preferable.

L²³ represents a divalent linking group selected from the group consisting of —O—, —S—, —C(═O)—, —SO₂—, —NH—, —CH₂—, —CH═CH—, —C≡C—, and a combination of these. Herein, a hydrogen atom of —NH—, —CH₂—, and —CH═CH— may be substituted with a substituent. Preferable examples of the substituent include a halogen atom, a cyano group, a nitro group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, a carbamoyl group substituted with alkyl having 2 to 6 carbon atoms, and an acylamino group having 2 to 6 carbon atoms. Among these, a halogen atom and an alkyl group having 1 to 6 carbon atoms are more preferable. If the hydrogen atom is substituted with the above substituent, when a liquid crystalline composition is prepared from the liquid crystal compound of the present invention, the solubility of the compound in a solvent to be used can be improved.

L²³ is preferably selected from the group consisting of —O—, —C(═O)—, —CH₂—, —CH═CH—, —C≡C—, and a combination of these. L²³ preferably contains 1 to 20 carbon atoms, and more preferably contains 2 to 14 carbon atoms. Furthermore, L²³ preferably contains 1 to 16 —CH₂—, and more preferably contains 2 to 12 —CH₂—.

Q¹ represents a polymerizable group or a hydrogen atom. The definition of the polymerizable group is as described above.

The polymerizable group is particularly preferably a functional group that can cause an addition polymerization reaction. Such a polymerizable group is preferably an ethylenically unsaturated polymerizable group or a ring-opening polymerizable group.

Examples of the ethylenically unsaturated polymerizable group include the following Formulae (M-1) to (M-6).

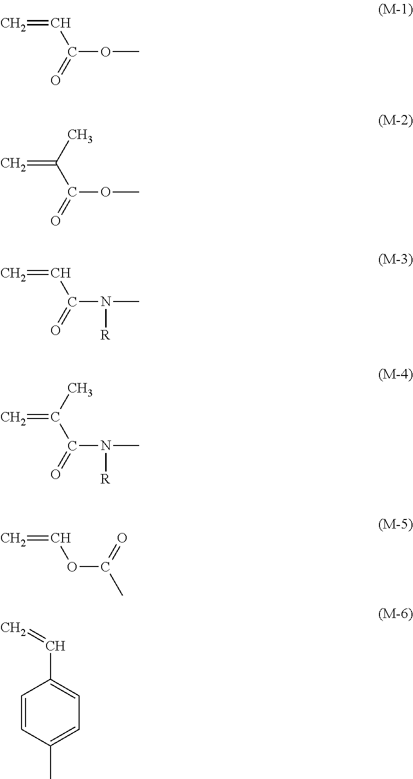

In Formulae (M-3) and (M-4), R represents a hydrogen atom or an alkyl group, and is preferably a hydrogen atom or a methyl group.

Among Formulae (M-1) to (M-6), (M-1) or (M-2) is preferable, and (M-1) is more preferable.

The ring-opening polymerizable group is preferably a cyclic ether group, and more preferably an epoxy group or an oxetanyl group.

Among the compounds represented by Formula (I), a compound represented by the following Formula (I′) is more preferable.

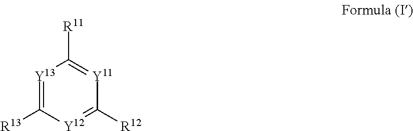

In Formula (I′), each of Y¹¹, Y¹², and Y¹³ independently represents either methane, which may have a substituent, or a hydrogen atom. Each of Y¹¹, Y¹², and Y¹³ is preferably methine which may have a substituent, and the methine is preferably unsubstituted.

Each of R¹¹, R¹², and R¹³ independently represents the following Formula (I′-A), (I′-B), or (I′-C). In order to reduce the wavelength dispersibility of intrinsic birefringence, Formula (I′-A) or (I′-C) is preferable, and Formula (I′-A) is more preferable. It is preferable that R¹¹, R¹², and R¹³ satisfy R¹¹=R¹²=R¹³.

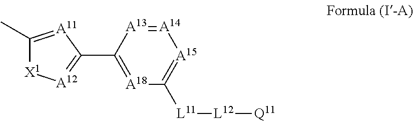

In Formula (I′-A), each of A¹¹, A¹², A¹³, A¹⁴, A¹⁵, and A¹⁶ independently represents either methane, which may have a substituent, or a nitrogen atom.

Preferably, at least one of A¹¹ and A¹² is a nitrogen atom. More preferably, both of A¹¹ and A¹² are nitrogen atoms.

Preferably, at least three out of A¹³, A¹⁴, A¹⁵, and A¹⁶ are methine which may have a substituent. More preferably, all of A¹³, A¹⁴, A¹⁵, and A¹⁶ are methine which may have a substituent. Furthermore, the methine is preferably unsubstituted.

When A¹¹, A¹², A¹³, A¹⁴, A¹⁵, or A¹⁶ is methine which may have a substituent, examples of the substituent include a halogen atom (a fluorine atom, a chlorine atom, a bromine atom, or an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, a carbamoyl group substituted with alkyl having 2 to 16 carbon atoms, and an acylamino group having 2 to 16 carbon atoms. Among these, a halogen atom, a cyano group, an alkyl group having 1 to 6 carbon atoms, and a halogen-substituted alkyl group having 1 to 6 carbon atoms are preferable, a halogen atom, an alkyl group having 1 to 4 carbon atoms, and a halogen-substituted alkyl group having 1 to 4 carbon atoms are more preferable, and a halogen atom, an alkyl group having 1 to 3 carbon atoms, and a trifluoromethyl group are even more preferable.

X¹ represents an oxygen atom, a sulfur atom, methylene, or imino, and is preferably an oxygen atom.

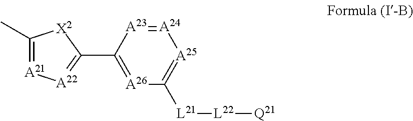

In Formula (I′-B), each of A²¹, A²², A²³, A²⁴, A²⁵, and A²⁶ independently represents either methane, which may have a substituent, or a nitrogen atom.

Preferably, at least one of A²¹ and A²² is a nitrogen atom. More preferably, both of A²¹ and A²² are nitrogen atoms.

Preferably, at least three out of A²³, A²⁴, A²⁵, and A²⁶ are methine which may have a substituent. More preferably, all of A²³, A²⁴, A²⁵, and A²⁶ are methine which may have a substituent. Furthermore, the methine is preferably unsubstituted.

When A²¹, A²², A²³, A²⁴, A²⁵, or A²⁶ is methine which may have a substituent, examples of the substituent include a halogen atom (a fluorine atom, a chlorine atom, a bromine atom, or an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, a carbamoyl group substituted with alkyl having 2 to 16 carbon atoms, and an acylamino group having 2 to 16 carbon atoms. Among these, a halogen atom, a cyano group, an alkyl group having 1 to 6 carbon atoms, and a halogen-substituted alkyl group having 1 to 6 carbon atoms are preferable, a halogen atom, an alkyl group having 1 to 4 carbon atoms, and a halogen-substituted alkyl group having 1 to 4 carbon atoms are more preferable, and a halogen atom, an alkyl group having 1 to 3 carbon atoms, and a trifluoromethyl group are even more preferable.

X² represents an oxygen atom, a sulfur atom, methylene, or imino, and is preferably an oxygen atom.

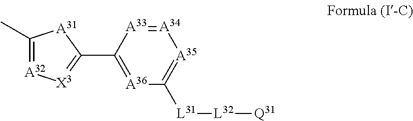

In Formula (I′-C), each of A³¹, A³², A³³, A³⁴, A³⁵, and A³⁶ independently represents either methane, which may have a substituent, or a nitrogen atom.

Preferably, at least one of A³¹ and A³² is a nitrogen atom. More preferably, both of A³¹ and A³² are nitrogen atoms.

Preferably, at least three out of A³³, A³⁴, A³⁵, and A³⁶ are preferably methine which may have a substituent. More preferably, all of A³³, A³⁴, A³⁵, and A³⁶ are methine which may have a substituent. Furthermore, the methine is preferably unsubstituted.

When A³¹, A³², A³³, A³⁴, A³⁵, or A³⁶ is methine which may have a substituent, the methine may have a substituent. Examples of the substituent include a halogen atom (a fluorine atom, a chlorine atom, a bromine atom, or an iodine atom), a cyano group, a nitro group, an alkyl group having 1 to 16 carbon atoms, an alkenyl group having 2 to 16 carbon atoms, an alkynyl group having 2 to 16 carbon atoms, a halogen-substituted alkyl group having 1 to 16 carbon atoms, an alkoxy group having 1 to 16 carbon atoms, an acyl group having 2 to 16 carbon atoms, an alkylthio group having 1 to 16 carbon atoms, an acyloxy group having 2 to 16 carbon atoms, an alkoxycarbonyl group having 2 to 16 carbon atoms, a carbamoyl group, a carbamoyl group substituted with alkyl having 2 to 16 carbon atoms, and an acylamino group having 2 to 16 carbon atoms. Among these, a halogen atom, a cyano group, an alkyl group having 1 to 6 carbon atoms, and a halogen-substituted alkyl group having 1 to 6 carbon atoms are preferable, a halogen atom, an alkyl group having 1 to 4 carbon atoms, and a halogen-substituted alkyl group having 1 to 4 carbon atoms are more preferable, and a halogen atom, an alkyl group having 1 to 3 carbon atoms, and a trifluoromethyl group are even more preferable.

X³ represents an oxygen atom, a sulfur atom, methylene, or imino, and is preferably an oxygen atom.

Each of L¹¹ in Formula (I′-A), L²¹ in Formula (I′-B), and L³¹ in Formula (I′-C) independently represents —O—, —C(═O)—, —O—CO—, —CO—O—, —O—CO—O—, —S—, —NH—, —SO₂—, —CH₂—, —CH═CH—, or —C≡C—. Among these, —O—, —C(═O)—, —O—CO—, —CO—O—, —O—CO—O—, —CH₂—, —CH═CH—, and —C≡C— are preferable, and —O—, —O—CO—, —CO—O—, —O—CO—O—, and —C≡C— are more preferable. Particularly, as L¹¹ in Formula (I′-A) that is expected to reduce the wavelength dispersibility of intrinsic birefringence, —O—, —CO—O—, and are preferable. Among these, —CO—O— is preferable, since this can exhibit a discotic nematic phase at a higher temperature. When the aforementioned group is a group containing a hydrogen atom, the hydrogen atom may be substituted with a substituent. Preferable examples of the substituent include a halogen atom, a cyano group, a nitro group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, a carbamoyl group substituted with alkyl having 2 to 6 carbon atoms, and an acylamino group having 2 to 6 carbon atoms. Among these, a halogen atom and an alkyl group having 1 to 6 carbon atoms are more preferable.

Each of L¹² in Formula (I′-A), L²² in Formula (I′-B), and L³² in Formula (I′-C) independently represents a divalent linking group selected from the group consisting of —O—, —S—, —C(═O)—, —SO₂—, —NH—, —CH₂—, —CH≡CH—, and a combination of these. Herein, a hydrogen atom in —NH—, —CH₂—, and —CH═CH— may be substituted with a substituent. Preferable examples of the substituent include a halogen atom, a cyano group, a nitro group, a hydroxyl group, a carboxyl group, an alkyl group having 1 to 6 carbon atoms, a halogen-substituted alkyl group having 1 to 6 carbon atoms, an alkoxy group having 1 to 6 carbon atoms, an acyl group having 2 to 6 carbon atoms, an alkylthio group having 1 to 6 carbon atoms, an acyloxy group having 2 to 6 carbon atoms, an alkoxycarbonyl group having 2 to 6 carbon atoms, a carbamoyl group, a carbamoyl group substituted with alkyl having 2 to 6 carbon atoms, and an acylamino group having 2 to 6 carbon atoms. Among these, a halogen atom, a hydroxyl group, and an alkyl group having 1 to 6 carbon atoms are more preferable, and a halogen atom, a methyl group, and an ethyl group are particularly preferable.

It is preferable that each of L²², L²², and L³² is independently selected from the group consisting of —O—, —C(═O)—, —CH₂—, —CH═CH—, —C≡C—, and a combination of these.

Preferably, each of L¹², L²², and L³² independently has 1 to 20 carbon atoms, and more preferably, each of L¹², L²², and L³² independently has 2 to 14 carbon atoms. Preferably, each of L¹², L²², and L³² independently has 1 to 16 —CH₂—, and more preferably, each of L¹², L²², and L³² independently has 2 to 12 —CH₂—.

The number of carbon atoms constituting each of L¹², L²², and L³² exerts an influence on the phase transition temperature of the liquid crystal and on the solubility of the compound in a solvent. Generally, as the number of carbon atoms increases, the temperature of transition from a discotic nematic phase (ND phase) to isotropic liquid tends to decrease. Moreover, generally, as the number of carbon atoms increases, the solubility in a solvent tends to be improved.

Each of Q¹¹ in Formula (I′-A), Q²² in Formula (I′-B), and Q³¹ in Formula (I′-C) independently represents a polymerizable group or a hydrogen atom. It is preferable that each of Q¹¹, Q²¹, and Q³² is a polymerizable group. Examples of the polymerizable group include the same polymerizable groups as exemplified above, and preferable examples thereof are also the same.

Specific examples of the compound represented by Formula (I) include the compounds described in paragraphs [0038] to in JP 2009-97002 A, but the present invention is not limited thereto.

[Rod-Like Liquid Crystal Compound] As the rod-like liquid crystal compound, azomethines, azoxies, cyanobiphenyls, cyanophenyl esters, benzoic acid esters, cyclohexane carboxylic acid phenyl esters, cyanophenyl cyclohexanes, cyano-substituted phenylpyrimidines, alkoxy-substituted phenylpyrimidines, phenyldioxanes, tolans, and alkenylcyclohexyl benzonitriles are preferably used. In addition to these low-molecular weight liquid crystal compounds, high-molecular weight liquid crystal compounds can also be used. The alignment of the rod-like liquid crystal compound is more preferably fixed by polymerization.

The rod-like liquid crystal compound contains a polymerizable group that can cause a polymerization or crosslinking reaction with actinic rays, electron beams, heat, or the like. The definition of the polymerizable group is as described above, and the number of polymerizable groups contained in the rod-like liquid crystal compound is preferably 1 to 6, and more preferably 1 to 3. As the polymerizable rod-like liquid crystal compound, it is possible to use the compounds described in Makromol. Chem., vol. 190, p. 2255 (1989); Advanced Materials, vol. 5, p. 107 (1993); U.S. Pat. No. 4,683,327 B; U.S. Pat. No. 5,622,648 B; U.S. Pat. No. 5,770,107 B; WO 95/22586; WO 95/24455; WO 97/00600; WO 98/23580; WO 98/52905; JP 1-272551 A; JP 6-16616 A; JP 7-110469 A; JP 11-80081 A; JP 2001-328973 A; and the like.

[Vertical Alignment Promoting Agent]

At the time of forming the optically anisotropic layer A and the optically anisotropic layer B, in order to vertically and uniformly align the molecules of the liquid crystal compound, it is preferable to use an alignment control agent that can cause the liquid crystal compound to be vertically aligned at the side of the alignment film interface and at the side of the air interface. For the aforementioned purpose, it is preferable to form an optically anisotropic layer by using a composition containing a liquid crystal compound together with a compound which has a function of vertically aligning a liquid crystal compound on an alignment film which will be described later by the excluded volume effect, the electrostatic effect, or the surface energy effect. Furthermore, with respect to the alignment control at the side of the air interface, it is preferable to form an optically anisotropic layer by using a composition containing a liquid crystal compound together with a compound which is localized in the air interface at the time of aligning the liquid crystal compound and has a function of vertically aligning the liquid crystal compound by the excluded volume effect, the electrostatic effect, or the surface energy effect. As the compound that promotes vertical alignment of the molecules of the liquid crystal compound at the side of the alignment film interface (vertical alignment agent for the side of the alignment film interface), pyridinium derivatives are suitably used. As the compound that promotes vertical alignment of the molecules of the liquid crystal compound at the side of the air interface (vertical alignment agent for the side of the air interface), compounds containing a fluoroaliphatic group, which promote localization of the compound at the side of the air interface, and one or more kinds of hydrophilic group selected from the group consisting of a carboxyl group (—COOH), a sulfo group (—SO₃H), a phosphonoxy group {—OP(═O)(OH)₂}, and salts of these are suitably used. If these compounds are mixed together, for example, when a liquid crystalline composition is prepared in the form of a coating liquid, coating properties of the coating liquid are improved, and the occurrence of unevenness and cissing is inhibited.

[Vertical Alignment Agent for Side of Alignment Film Interface]

As the vertical alignment agent for the side of the alignment film interface that can be used in the present invention, a pyridinium derivative (a pyridinium salt) represented by the following Formula (II) is suitably used. By adding at least one kind of the pyridinium derivative to the aforementioned composition, it is possible to make the molecules of the discotic liquid crystal compound be substantially vertically aligned in the vicinity of the alignment film.

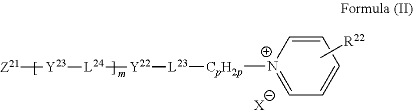

In the formula, each of L²³ and L²⁴ independently represents a divalent linking group.

L²³ is preferably a single bond, —O—, —O—CO—, —CO—O—, —CH═CH—, —CH═N—, —N═CH—, —N═N—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-OCO—, or —O—CO-AL-CO—O—. AL is an alkylene group having 1 to 10 carbon atoms. L²³ is preferably a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—, more preferably a single bond or —O—, and most preferably —O—.

L²⁴ is preferably a single bond, —O—, —O—CO—, —CO—O—, —C≡C—, —CH═CH—, —CH═N—, —N═CH—, or —N═N—, and more preferably —O—CO— or —CO—O—. When m is equal to or greater than 2, a plurality of L²⁴ more preferably alternates between —O—CO— and —CO—O—.

R²² is a hydrogen atom, an unsubstituted amino group, or a substituted amino group having 1 to 25 carbon atoms.

When R²² is a dialkyl-substituted amino group, two alkyl groups may form a nitrogen-containing heterocyclic ring by being bonded to each other. The nitrogen-containing heterocyclic ring formed in this manner is preferably a 5-membered ring or a 6-membered ring. R²² is more preferably a hydrogen atom, an unsubstituted amino group, or a dialkyl-substituted amino group having 2 to 12 carbon atoms, and even more preferably a hydrogen atom, an unsubstituted amino group, or a dialkyl-substituted amino group having 2 to 8 carbon atoms. When R²² is an unsubstituted amino group or a substituted amino group, it is preferable that the 4-position of the pyridinium ring is substituted.

X is an anion.

X is preferably a monovalent anion. Examples of the anion include a halogen ion (for example, a fluorine ion, a chlorine ion, a bromine ion, or an iodine ion), a sulfonate ion (for example, a methanesulfonate ion, trifluoromethanesulfonate ion, a methyl sulfate ion, a p-toluenesulfonate ion, a p-chlorobenzenesulfonate ion, a 1,3-benzenedisulfonate ion, a 1,5-naphthalenedisulfonate ion, or a 2,6-naphthalenedisulfonate ion), a sulfate ion, a carbonate ion, a nitrate ion, a thiocyanate ion, a perchlorate ion, a tetrafluoroborate ion, a picrate ion, an acetate ion, a formate ion, a trifluoroacetate ion, a phosphate ion (for example, a hexafluorophosphate ion), a hydroxide ion, and the like. X is preferably a halogen anion, a sulfonate ion, or a hydroxide ion.

Each of Y²² and Y²³ is a divalent linking group having a 5- or 6-membered ring as a partial structure.

The 5- or 6-membered ring may have a substituent. At least one of Y²² and Y²³ is preferably a divalent linking group having a 5- or 6-membered ring, which has a substituent, as a partial structure. It is preferable that each of Y²² and Y²³ is independently a divalent linking group having a 6-membered ring, which may have a substituent, as a partial structure. The 6-membered ring includes an aliphatic ring, an aromatic ring (a benzene ring), and a heterocyclic ring. Examples of the 6-membered aliphatic ring include a cyclohexane ring, a cyclohexene ring, and a cyclohexadiene ring. Examples of the 6-membered heterocyclic ring include a pyran ring, a dioxane ring, a dithiane ring, a thiin ring, a pyridine ring, a piperidine ring, an oxazine ring, a morpholine ring, a triazine ring, a pyridazine ring, a pyrimidine ring, a pyrazine ring, a piperazine ring, and a triazine ring. Other 6-membered or 5-membered rings may be condensed with the 6-membered ring.

Examples of the substituent include a halogen atom, cyano, an alkyl group having 1 to 12 carbon atoms, and an alkoxy group having 1 to 12 carbon atoms. The alkyl group and the alkoxy group may be substituted with an acyl group having 2 to 12 carbon atoms or an acyloxy group having 2 to 12 carbon atoms. The substituent is preferably an alkyl group having 1 to 12 carbon atoms (more preferably having 1 to 6 carbon atoms, and even more preferably having 1 to 3 carbon atoms). The number of substituents may be equal to or greater than 2. For example, when each of Y²² and Y²³ is a phenylene group, the phenylene group may be substituted with 1 to 4 alkyl groups having 1 to 12 carbon atoms (more preferably having 1 to 6 carbon atoms, and even more preferably having 1 to 3 carbon atoms).

m is 1 or 2, and is preferably 2. When m is 2, a plurality of Y²³ and L²⁴ may be the same as or different from each other.

Z²¹ is a monovalent group selected from the group consisting of halogen-substituted phenyl, nitro-substituted phenyl, cyano-substituted phenyl, phenyl substituted with an alkyl group having 1 to 25 carbon atoms, phenyl substituted with an alkoxy group having 1 to 25 carbon atoms, an alkyl group having 1 to 25 carbon atoms, an alkynyl group having 2 to 25 carbon atoms, an alkoxy group having 1 to 25 carbon atoms, an alkoxycarbonyl group having 1 to 25 carbon atoms, an aryloxycarbonyl group having 7 to 26 carbon atoms, and an arylcarbonyloxy group having 7 to 26 carbon atoms.

When m is 2, Z²¹ is preferably cyano, an alkyl group having 1 to 25 carbon atoms, or an alkoxy group having 1 to 25 carbon atoms, and more preferably an alkoxy group having 4 to 20 carbon atoms.

When m is 1, Z²¹ is preferably an alkyl group having 7 to 25 carbon atoms, an alkoxy group having 7 to 25 carbon atoms, an acyl-substituted alkyl group having 7 to 25 group, an acyl-substituted alkoxy group having 7 to 25 carbon atoms, an acyloxy-substituted alkyl group having 7 to 12 carbon atoms, or an acyloxy-substituted alkoxy group having 7 to 25 carbon atoms.

An acyl group is represented by —CO—R, and an acyloxy group is represented by —O—CO—R. R is an aliphatic group (an alkyl group, a substituted alkyl group, an alkenyl group, a substituted alkenyl group, an alkynyl group, or a substituted alkynyl group) or an aromatic group (an aryl group or a substituted aryl group). R is preferably an aliphatic group, and more preferably an alkyl group or an alkenyl group.

p is an integer of 1 to 10, and is particularly preferably 1 or 2. CₚH₂ₚ represents a chain-like alkylene group which may have a branched structure. CₚH₂ₚ is preferably a linear alkylene group (—(CH₂)ₚ—).

Among the compounds represented by Formula (II), a compound represented by the following Formula (II′) is preferable.

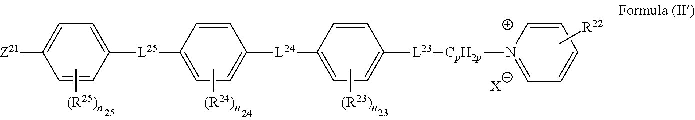

In Formula (II′), the same reference numerals as used in Formula (II) have the same definition, and a preferable range thereof is also the same. L²⁵ has the same definition as L²⁴, and a preferable range thereof is also the same. Each of L²⁴ and L²⁵ is preferably —O—CO— or —CO—O—. It is preferable that L²⁴ is —O—CO— and L²⁵ is —CO—O—.

Each of R²³, R²⁴, and R²⁵ is an alkyl group having 1 to 12 carbon atoms (more preferably having 1 to 6 carbon atoms, and even more preferably having 1 to 3 carbon atoms). n₂₃ represents 0 to 4, n₂₄ represents 1 to 4, and n₂₅ represents 0 to 4. It is preferable that each of n₂₃ and n₂₅ is 0 and n₂₄ is 1 to 4 (more preferably 1 to 3).

Specific examples of the compound represented by Formula (II) include the compounds described in paragraphs [0058] to [0061] in JP 2006-113500 A.

[Vertical Alignment Agent for Side of Air Interface]

As the vertical alignment agent for the side of the air interface, the following fluorine-based polymer (having a partial structure represented by Formula (III)) or a fluorine-containing compound represented by the following Formula (III) is suitably used.

First, the fluorine-based polymer (having a partial structure represented by Formula (II)) will be described. The vertical alignment agent for the side of the air interface of the present invention is preferably a copolymer in which the fluorine-based polymer contains a repeating unit derived from a fluoroaliphatic group-containing monomer and a repeating unit represented by the following Formula (II).

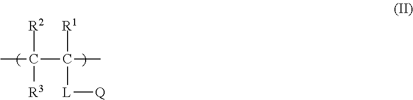

In the formula, each of R², R², and R³ independently represents a hydrogen atom or a substituent; and L represents either a divalent linking group selected from the following group of linking groups or a divalent linking group composed of a combination of two or more kinds selected from the following group of linking groups.

(Group of Linking Groups)

The group of linking groups consists of a single bond, —O—, —CO—, —NR⁴—(R⁴ represents a hydrogen atom, an alkyl group, an aryl group, or an aralkyl group), —S—, —SO₂—, —P(═O) (OR⁵)— (R⁵ represents an alkyl group, an aryl group, or an aralkyl group), an alkylene group, and an arylene group.

Q represents a carboxyl group (—COOH) or a salt thereof, a sulfo group (—SO₃H) or a salt thereof, or a phosphonoxy group {-OP(═O) (OH)₂} or a salt thereof.

The characteristic of the fluorine-based polymer usable in the present invention is that it contains a fluoroaliphatic group and one or more kinds of hydrophilic group selected from the group consisting of a carboxyl group (—COOH), a sulfo group (—SO₃H), a phosphonoxy group {—OP(═O) (OH)₂}, and salts of these. The type of the polymer is described on pages 1 to 4 in “Chemistry of Polymer Synthesis (revised edition)” (Otsu Takayuki, Kagaku-Dojin Publishing Company, INC., 1968). Examples of the polymer include polyolefins, polyesters, polyamides, polyimides, polyurethanes, polycarbonates, polysulfones, polyethers, polyacetals, polyketones, polyphenylene oxides, polyphenylene sulfides, polyarylates, PTFEs, polyvinylidene fluorides, cellulose derivatives, and the like. As the fluorine-based polymer, polyolefins are preferable.

The fluorine-based polymer is a polymer having a fluoroaliphatic group on the side chain thereof. The fluoroaliphatic group preferably has 1 to 12 carbon atoms, and more preferably has 6 to 10 carbon atoms. The aliphatic group may be chain-like or cyclic. When the aliphatic group is chain-like, it may be linear or branched. Particularly, a linear fluoroaliphatic group having 6 to 10 carbon atoms is preferable. The degree of substitution with fluorine atoms is not particularly limited. However, preferably, 50% or more of hydrogen atoms in the aliphatic group are substituted with fluorine atoms, and more preferably, 60% or more of hydrogen atoms are substituted with fluorine atoms. The fluorine-based polymer contains the fluoroaliphatic group on the side chain thereof that has been bonded to the main chain thereof through an ester bond, an amide bond, an imide bond, a urethane bond, a urea bond, an ether bond, a thioether bond, an aromatic ring, or the like.

Specific examples of the fluoroaliphatic group-containing copolymer preferably used as the fluorine-based polymer include the compounds described in paragraphs [0110] to [0114] in JP 2006-113500 A and the like. However, the present invention is not limited to these specific examples.

The mass-average molecular weight of the fluorine-based polymer is preferably equal to or less than 1,000,000, more preferably equal to or less than 500,000, and even more preferably equal to or less than 100,000 and equal to or greater than 10,000. If the mass-average molecular weight is within the above range, it is possible to effectively control the alignment of the liquid crystal compound while satisfying the solubility. The mass-average molecular weight can be measured by gel permeation chromatography (GPC) and expressed in terms of polystyrene (PS).

The preferable range of the content of the fluorine-based polymer in the composition varies with the use thereof. However, when the composition is used for forming an optically anisotropic layer, the content of the fluorine-based polymer in the composition (the composition excluding a solvent when it is used in the form of coating liquid) is preferably 0.005% by mass to 8% by mass, more preferably 0.01% by mass to 5% by mass, and even more preferably 0.05% by mass to 3% by mass. If the amount of the fluorine-based polymer added is less than 0.005% by mass, the effect becomes insufficient, and if it is greater than 8% by mass, the coating film does not thoroughly dry, or the performance (for example, uniformity of retardation) of the optical film is negatively influenced.

In the present invention, a fluorine-containing compound represented by the following Formula (III) can also be used.

(R⁰)ₘ-L⁰-(W)ₙ (III)

In the formula, R⁰ represents an alkyl group, an alkyl group having a CF₃ group on the terminal thereof, or an alkyl group having a CF₂H group on the terminal thereof. m represents an integer of equal to or greater than 1. A plurality of R⁰s may be the same as or different from each other, but at least one of R⁰s represents an alkyl group having a CF₃ group or a CF₂H group on the terminal thereof. L⁰ represents a linking group having a valency of (m+n). W represents a carboxyl group (—COOH) or a salt thereof, a sulfo group (—SO₃H) or a salt thereof, or a phosphonoxy group {—OP(═O)(OH)₂} or a salt thereof. n represents an integer of equal to or greater than 1.

Specific examples of the fluorine-containing compound represented by Formula (III) that is usable in the present invention include the compounds described in paragraphs [0136] to [0140] in JP 2006-113500 A, and the like, but the present invention is not limited to these specific examples.

The preferable range of the content of the fluorine-containing compound in the composition varies with the use thereof. However, when the composition is used for forming an optically anisotropic layer, the content of the fluorine-containing compound in the composition (the composition excluding a solvent when it is used in the form of coating liquid) is preferably 0.005% by mass to 8% by mass, more preferably 0.01% by mass to 5% by mass, and even more preferably 0.05% by mass to 3% by mass.

The fluorine-containing compound does not have a functional group (a polymerizable group) that can form a covalent bond together with a binder (a liquid crystal compound, an acrylate monomer, or the like) contained in the optically anisotropic layer.

[Polymerization Initiator]

The aligned (preferably vertically aligned) liquid crystal compound is fixed while maintaining the aligned state. It is preferable for the liquid crystal compound to be fixed by a polymerization reaction of the polymerizable groups (P) introduced to the liquid crystal compound. The polymerization reaction includes a thermal polymerization reaction using a thermal polymerization initiator and a photopolymerization reaction using a photopolymerization initiator. Particularly, a photopolymerization reaction is preferable. Examples of the polymerization initiator include α-carbonyl compounds (described in U.S. Pat. No. 2,367,661 B and U.S. Pat. No. 2,367,670 B), acyloin ethers (described in U.S. Pat. No. 2,448,828 B), α-hydrocarbon-substituted aromatic acyloin compounds (described in U.S. Pat. No. 2,722,512 B), polynuclear quinone compounds (described in U.S. Pat. No. 3,046,127 B and U.S. Pat. No. 2,951,758 B), a combination of a triaryl imidazole dimer and p-aminophenylketone (described in U.S. Pat. No. 3,549,367 B), acridine and phenazine compounds (described in JP 60-105667 A and U.S. Pat. No. 4,239,850 B), and oxadiazole compounds (described in U.S. Pat. No. 4,212,970 B).

The amount of the polymerization initiator used is preferably 0.01% by mass to 20% by mass and more preferably 0.5% by mass to 5% by mass of solid contents of the composition.

[Other Additives for Optically Anisotropic Layer]

The above liquid crystal compound can be concurrently used with a plasticizer, a surfactant, a polymerizable monomer, and the like to improve uniformity of the coating film, film strength, alignment properties of the liquid crystal compound, and the like. It is preferable for those materials used concurrently to be compatible with the liquid crystal compound and not to hinder the alignment.

Examples of the polymerizable monomer include radically polymerizable monomers and cationically polymeriable monomers. Among these, radically polymerizable polyfunctional monomers that can be copolymerized with the aforementioned polymerizable group-containing liquid crystal compounds are preferable. Examples thereof include those described in paragraphs [0018] to [0020] in JP 2002-296423 A. The amount of the above compounds added is generally in a range of 1% by mass to 50% by mass, and preferably in a range of 5% by mass to 30% by mass, based on the liquid crystal compound.

Examples of the surfactant include conventionally known compounds, and among these, fluorine-based compounds are particularly preferable. Specific examples thereof include compounds described in paragraphs [0028] to [0056] of JP 2001-330725 A and paragraphs [0069] to [0126] in Japanese Patent Application No. 2003-295212.

It is preferable for the polymer used concurrently with the liquid crystal compound to be able to thicken the coating liquid. Examples of the polymer include cellulose esters. Preferable examples of the cellulose esters include those described in a paragraph [0178] of JP 2000-155216 A. The amount of the polymer added is preferably in a range of 0.1% by mass to 10% by mass, and more preferably in a range of 0.1% by mass to 8% by mass, based on the liquid crystal compound, such that the alignment of the liquid crystal compound is not hindered.

The discotic nematic liquid crystal phase-solid phase transition temperature of the liquid crystal compound is preferably 70° C. to 300° C. and more preferably 70° C. to 170° C.

[Coating Solvent]

As the solvent used for preparing the composition (coating liquid), organic solvents are preferably used. Examples of the organic solvents include amide (for example, N,N-dimethylformamide), sulfoxide (for example, dimethyl sulfoxide), heterocyclic compounds (for example, pyridine), hydrocarbon (for example, benzene and hexane), alkyl halide (for example, chloroform and dichloromethane), ester (for example, methyl acetate, ethyl acetate, and butyl acetate), ketone (for example, acetone and methyl ethyl ketone), and ether (for example, tetrahydrofuran and 1,2-dimethoxyethane). Among these, alkyl halide and ketone are preferable. Two or more kinds of organic solvents may be concurrently used.

[Alignment Film]

In the present invention, it is preferable for the aforementioned composition to be applied to the surface of an alignment film to align molecules of the liquid crystal compound (for example, a discotic liquid crystal compound). The alignment film functions to determine the alignment direction of the liquid crystal compound. Accordingly, it is preferable for the alignment film to be used to realize preferable modes of the present invention. However, if the alignment state of the liquid crystal compound is fixed after the compound is aligned, the role of the alignment film is not required. Therefore, the alignment film is not an essential constituent of the present invention. That is, it is possible to prepare an optical base material for the optical film of the present invention by transferring only the optically anisotropic layer, which is disposed on the alignment film and in which the alignment state of the liquid crystal compound is fixed, to another transparent support.

The alignment film can be provided by means of rubbing processing of an organic compound (preferably a polymer), oblique deposition of an inorganic compound, formation of a layer having mocrogrooves, or accumulation of organic compounds (for example, o-tricosanoic acid, dioctadecyl methyl ammonium chloride, and methyl stearate) by the Langmuir-Blodgett method (LB film). Moreover, an alignment film which obtains an aligning function by being provided with electric or magnetic field or being irradiated with light (preferably polarized light) is known.

It is preferable for the alignment film to be formed by rubbing processing of a polymer.

Examples of the polymer include the polymers described in a paragraph [0022] of JP 8-338913 A such as methacrylate-based copolymers, styrene-based copolymers, polyolefin, polyvinyl alcohol, modified polyvinyl alcohol, poly(N-methylolacrylamide), polyester, polyimide, vinyl acetate copolymers, carboxymethyl cellulose, polycarbonate, and the like. Silane coupling agents can be used as the polymer. Among these, water-soluble polymers (for example, poly(N-methylolacrylamide), carboxymethyl cellulose, gelatin, polyvinyl alcohol, and modified polyvinyl alcohol) are preferable, gelatin, polyvinyl alcohol, and modified polyvinyl alcohol are more preferable, and polyvinyl alcohol and modified polyvinyl alcohol are most preferable.

A degree of saponification of the polyvinyl alcohol is preferably 70% to 100%, and more preferably 80% to 100%. A degree of polymerization of the polyvinyl alcohol is preferably 100 to 5,000.

In the alignment film, a side chain having a crosslinkable functional group (for example, a double bond) is preferably bonded to a main chain, or alternatively, a crosslinkable functional group, which has a function of aligning the liquid crystal compound, is preferably introduced into a side chain. As the polymer used in the alignment film, either a polymer that can be autonomously crosslinked or a polymer that is crosslinked with the aid of a crosslinking agent can be used. Moreover, a plurality of combinations of the aforementioned polymers can be used.

If the side chain having a crosslinkable functional group is bonded to the main chain of the polymer of the alignment film, or if the crosslinkable functional group is introduced into the side chain which has a function of aligning the liquid crystal compound, the polymer of the alignment film and the polyfunctional monomer contained in the optically anisotropic layer can be copolymerized. As a result, a strong covalent bond is formed not only between the polyfunctional monomers, but also between the polymers of the alignment film, and between the polyfunctional monomer and the polymer of the alignment film. Consequentially, by introducing the crosslinkable functional group into the polymer of the alignment film, it is possible to markedly improve the strength of an optical compensation sheet.

Similarly to the polyfunctional monomer, the crosslinkable functional group of the polymer of the alignment film preferably contains a polymerizable group. Specific examples of the polymerizable group include those described in paragraphs [0080] to [0100] in JP 2000-155216 A.

The polymer of the alignment film can also be crosslinked by using a crosslinking agent, separately from the aforementioned crosslinkable functional group. Examples of the crosslinking agent include aldehydes, N-methylol compounds, dioxane derivatives, compounds that function by activating a carboxyl group, active vinyl compounds, active halogen compounds, isoxazole, and dialdehyde starch. Two or more kinds of the crosslinking agent may be concurrently used. Specific examples thereof include the compounds described in paragraphs [0023] to [0024] in JP 2002-62426 A, and the like. As the crosslinking agent, a highly reactive aldehyde is preferable, and particularly, glutaraldehyde is preferable.

The amount of the crosslinking agent added is preferably 0.1% by mass to 20% by mass, and more preferably 0.5% by mass to 15% by mass, with respect to the polymer. The amount of the unreacted crosslinking agent remaining in the alignment film is preferably equal to or less than 1.0% by mass, and more preferably equal to or less than 0.5% by mass. If the amount of the crosslinking agent is regulated to be within the above range, even when the alignment film is used in a liquid crystal display apparatus for a long time or left in a high-temperature and high-humidity atmosphere for a long time, sufficient durability that does not cause reticulation can be obtained.

Basically, the alignment film can be formed by coating the transparent support with a solution, which contains the aforementioned polymer as the material for forming the alignment film, a crosslinking agent, and additives, then heating and drying (crosslinking) the solution, and performing rubbing processing on the resultant. The crosslinking reaction may be performed at any point in time after the transparent support is coated with the solution. When a water-soluble polymer such as polyvinyl alcohol is used as the material for forming the alignment film, the coating liquid is preferably in the form of a mixed solvent composed of an organic solvent (for example, methanol) having a defoaming function and water. The ratio of water:methanol is preferably 0:100 to 99:1, and more preferably 0:100 to 91:9, in terms of mass ratio. If the ratio is within the above range, the generation of bubbles is inhibited, and defects in the surface of the alignment film or defects in the surface of the optically anisotropic layer are markedly reduced.

As the coating method used for forming the alignment film, a spin coating method, a dip coating method, a curtain coating method, an extrusion coating method, a rod coating method, and a roll coating method are preferable, and among these, a rod coating method is more preferable. The film thickness after drying is preferably 0.1 μm to 10 μm. The heating and drying can be performed at a temperature of 20° C. to 110° C. In order to sufficiently form crosslinks, the temperature of the heating and drying is preferably 60° C. to 100° C., and particularly preferably 80° C. to 100° C. The drying can be performed for 1 minute to 36 hours, and is preferably performed for 1 minute to 30 minutes. Furthermore, it is preferable to set pH to the level optimal for the crosslinking agent used. When glutaraldehyde is used, pH of 4.5 to 5.5 is preferable.

As the rubbing processing, it is possible to use processing methods that are widely adopted as a liquid crystal alignment processing step for an LCD. That is, it is possible to use a method for obtaining alignment in which the surface of the alignment film is rubbed in a certain direction with paper, gauze, felt, rubber, nylon, polyester fiber, or the like. Generally, the rubbing processing is performed by rubbing the surface of the alignment film about several times with cloth or the like in which fibers having the uniform length and thickness are evenly flocked.

<Polarizing Film>

The polarizing film (polarizing layer) may be a member that functions to converting natural light into specific linearly-polarized light, and absorptive polarizer can be used.

The type of the polarizing film is not particularly limited, and generally used polarizing films can be used. For example, it is possible to use any of iodine-based polarizing films, dye-based polarizing films using dichroic dyes, and polyene-based polarizing films. The iodine-based polarizing films and the dye-based polarizing films are generally prepared by causing iodine or dichroic dyes to be adsorbed onto polyvinyl alcohol and stretching the resultant.

The polarizing film is generally used in the form of a polarizing plate obtained by pasting protective films to both sides thereof.

<Optical Laminate>

A haze value X of the optical laminate (optical film) including the transparent support, the optically anisotropic layer A, and the optically anisotropic layer B described above satisfies the following Expression (4).

X<0.5% Expression (4)

Particularly, the haze value X is preferably equal to or less than 0.4%, and more preferably equal to or less than 0.3%.

If the haze value X is equal to or greater than 0.5%, when the optical laminate is stuck on a polarization plate and then evaluated after being mounted on a display apparatus, white turbidity is observed, and the visibility thereof is reduced.

The haze value X corresponds to the total haze value (H) measured based on JIS-K7136. As the measurement apparatus, a haze meter NDH 2000 manufactured by NIPPON DENSHOKU INDUSTRIES Co., LTD is used.

The Rth of the optical laminate is not particularly limited. However, in view of better viewing angle characteristics, the Rth preferably satisfies the relationship of the following Expression (5).

−100 nm≦Rth(550)≦100 nm Expression (5)

Particularly, in view of better viewing angle characteristics, Rth (550) is preferably −80 nm to 80 nm, and more preferably −60 nm to 60 nm.

<Circularly Polarizing Plate>

The circularly polarizing plate of the present invention constituted as above is preferably used for preventing reflection caused in an image display apparatus such as a liquid crystal display (LCD), a plasma display panel (PDP), an electroluminescence display (ELD), or a cathode ray tube (CRT) display apparatus.

For example, there is an embodiment in which the circularly polarizing plate of the present invention is used at the side of light extraction surface of an organic EL display apparatus. In this case, external light becomes linearly-polarized light by the polarizing film and then becomes circularly-polarized light by passing through the optical laminate. When the circularly-polarized light is reflected from a metal electrode, the circularly polarized state is inverted. When the circularly-polarized light passes again through the optical laminate, it becomes linearly polarized light inclining by 90° from the time when the light enters the optical laminate, and reaches and is absorbed by the polarizing film. As a result, the influence of the external light can be suppressed.

<Method for Manufacturing Circularly Polarizing Plate>

The method for manufacturing the aforementioned circularly polarizing plate is preferably performed in order of the following steps (1) to (7). Particularly, if at least the following step (3) is performed, it is possible to manufacture a circularly polarizing plate that brings about the intended effects described above.

Step (1) a step of forming an alignment film on a transparent support

Step (2) a step of aligning a discotic liquid crystal compound by coating the alignment film with a composition, which contains a discotic liquid crystal compound having a polymerizable group, and performing heating processing on the composition if necessary

Step (3) a step of forming an optically anisotropic layer A by performing ultraviolet irradiation processing on the discotic liquid crystal compound having a polymerizable group at an ultraviolet irradiation amount of equal to or greater than 100 mJ/cm² and less than 400 mJ/cm²

Step (4) a step of rubbing the surface of the optically anisotropic layer A in a direction orthogonal to the slow axis of the optically anisotropic layer A

Step (5) a step of aligning a rod-like liquid crystal compound by coating the rubbed optically anisotropic layer A with a composition, which contains a rod-like liquid crystal compound having a polymerizable group, and performing heating processing on the composition if necessary

Step (6) a step of forming an optically anisotropic layer B by performing curing processing on the rod-like liquid crystal compound having a polymerizable group

Step (7) a step of further disposing a polarizing film

Hereinafter, the procedure of each of the steps will be described.

The step (1) is a step of forming an alignment film on a transparent support. The method for forming the alignment film is as described above. The alignment film is preferably obtained by a method of crosslinking a polymer layer and then performing rubbing processing on the surface thereof.

The step (2) is a step of aligning a discotic liquid crystal compound by coating the alignment film with a composition, which contains a discotic liquid crystal compound having a polymerizable group, and performing heating processing on the composition if necessary.

The composition used is as described above.

The coating of the composition can be performed by known methods (for example, a wire bar coating method, an extrusion coating method, a direct gravure coating method, a reverse gravure coating method, and a die coating method).

As the conditions of the heating processing, the optimal temperature is appropriately selected according to the type of the discotic liquid crystal compound used. Generally, the heating processing is preferably performed for 10 seconds to 600 seconds (preferably for 30 seconds to 300 seconds) at a temperature of 20° C. to 200° C. (preferably at a temperature of 60° C. to 160° C.)

The step (3) is a step of forming an optically anisotropic layer A by performing ultraviolet irradiation processing on the aligned discotic liquid crystal compound having a polymerizable group at an ultraviolet irradiation amount of equal to or greater than 100 mJ/cm² and less than 400 mJ/cm². By performing the ultraviolet irradiation processing, a reaction is caused between polymerizable groups, and as a result, the alignment state is fixed. Particularly, presumably, if the ultraviolet irradiation amount is within the above range, the surface hardness of the optically anisotropic layer A to be formed may fall into a range suitable for rubbing processing performed in the following step, and thus the alignment of the rod-like liquid crystal compound may become excellent.

Particularly, in view of better alignment properties of the optically anisotropic layer B, the ultraviolet irradiation amount is preferably 100 mJ/cm² to 300 mJ/cm², and more preferably 100 mJ/cm² to 200 mJ/cm².

If the ultraviolet irradiation amount is less than 100 mJ/cm², the optically anisotropic layer. A is not sufficiently fixed, and thus the rubbing processing cannot be performed. Moreover, if the ultraviolet irradiation amount is equal to or greater than 400 mJ/cm², the surface of the optically anisotropic layer A is excessively cured, an excellent alignment state is not formed by the rubbing processing, and this leads to the alignment defect of the rod-like liquid crystal compound in the optically anisotropic layer B laminated on the optically anisotropic layer A.

In order to accelerate a photopolymerization reaction, the light irradiation may be performed under heating conditions. The temperature for fixing the alignment is not particularly limited. However, generally, the temperature is preferably equal to or less than 100° C., and more preferably equal to or less than 80° C. Moreover, in order to maintain the adhesiveness between the optically anisotropic layer A and the support, the optically anisotropic layer A is preferably cured at a temperature of equal to or higher than 40° C.

The state in which the alignment state is fixed refers to a most typical and preferable embodiment in which the alignment is maintained. However, the state is not limited to the embodiment, and specifically, it refers to a state in which the fixed composition does not exhibit fluidity in a temperature range of 0° C. to 50° C. in general or in a temperature range of −30° C. to 70° C. under harsher conditions, and the fixed alignment form can be stably maintained without being changed by an external field or external force.

The step (4) is a step of rubbing the surface of the optically anisotropic layer A in a direction orthogonal to the slow axis of the optically anisotropic layer A.

As the rubbing processing, processing methods that are widely adopted as a liquid crystal alignment processing step for an LCD can be used. That is, it is possible to use a method for obtaining alignment by rubbing the surface of the optically anisotropic layer A in a certain direction with paper, gauze, felt, rubber, nylon, polyester fiber, or the like. Generally, the rubbing processing is performed by rubbing the surface of the optically anisotropic layer A about several times with cloth or the like in which fibers having uniform length and thickness are evenly flocked.

The step (5) is a step of aligning a rod-like liquid crystal compound by coating the rubbed optically anisotropic layer A with a composition, which contains a rod-like liquid crystal compound having a polymerizable group, and performing heating processing on the composition if necessary.

The composition used is as described above.

Furthermore, the coating method of the composition is the same as the method used in the step (2).

The step (6) is a step of forming an optically anisotropic layer B by performing curing processing on the aligned rod-like liquid crystal compound having a polymerizable group.

The curing processing method is not particularly limited as long as a reaction is caused between the polymerizable groups. Examples of the method include heating processing and light irradiation processing (preferably ultraviolet irradiation processing).

The step (7) is a step of disposing a polarizing film. More specifically, it is a step of further disposing a polarizing film on the formed optically anisotropic layer B or the transparent support.

The method for disposing the polarizing film is not particularly limited. For example, the polarizing film is disposed on the optically anisotropic layer B or the transparent support through a pressure-sensitive adhesive layer or an adhesive layer not shown in the drawing. Moreover, for disposing (sticking) the polarizing film, a so-called roll-to-roll method may be used.

For example, the pressure-sensitive adhesive layer refers to a layer constituted with a substance in which a ratio between G′ and G″ (tan δ G″/G′) measured by a dynamic viscoelastometer. is 0.001 to 1.5. The substance includes a so-called pressure-sensitive adhesive, a readily creeping substance, and the like. The pressure-sensitive adhesive contained in the pressure-sensitive adhesive layer is not particularly limited, and for example, a polyvinyl alcohol-based pressure-sensitive adhesive can be used.

As adhesives used for the adhesive layer, for example, it is possible to use polyvinyl alcohol-based resins (including polyvinyl alcohols modified with an acetoacetyl group, a sulfonic acid group, a carboxyl group, or an oxyalkylene group) or aqueous boron compound solutions. Among these, polyvinyl alcohol-based resins are preferable.

The thickness of the pressure-sensitive adhesive layer and the adhesive layer after drying is preferably within a range of 0.01 μm to 10 μm, and particularly preferably within a range of 0.05 μm to 5 μm.

It is preferable to dispose a protective film on the other surface of the polarizing film on which the optically anisotropic layer B or the transparent substrate is not stuck.

### Second Embodiment

Hereinafter, a second embodiment of the circularly polarizing plate of the present invention will be described with reference to a drawing. FIG. 2 is a schematic cross-sectional view of the second embodiment of the circularly polarizing plate of the present invention.

A circularly polarizing plate 100 includes a polarizing film 18, a transparent support 12, an optically anisotropic layer A14, and an optically anisotropic layer B16 that are laminated on each other in this order. The angular relationship between the absorption axis of the polarizing film 18, the slow axis of the optically anisotropic layer A14, and the slow axis of the optically anisotropic layer B16 is not particularly limited, and for example, the angular relationship of the aforementioned first embodiment is established therebetween. For instance, when one of the optically anisotropic layer A and the optically anisotropic layer B is a λ/4 film, and the other is a λ/2 film, it is preferable that an angle of 45° is formed between the slow axis of the optically anisotropic layer as the λ/2 film and the absorption axis of the polarizing film, and the slow axis of the optically anisotropic layer A is orthogonal to the slow axis of the optically anisotropic layer B. More specifically, in the embodiment shown in FIG. 2, when the optically anisotropic layer A14 is a λ/2 film, and the optically anisotropic layer B16 is a λ/4 film, an embodiment is preferable in which an angle of 45° is formed between the absorption axis of the polarizing film 18 and the slow axis of the optically anisotropic layer A14, and the slow axis of the optically anisotropic layer A is orthogonal to the slow axis of the optically anisotropic layer B.

Except for the position of the polarizing film 18, constituents of the circularly polarizing plate 100 shown in FIG. 2 are the same as the constituents of the circularly polarizing plate 10 shown in FIG. 1. Therefore, the same constituents are marked with the same reference numerals, and the description thereof will be omitted.

As shown in FIG. 2, even when the polarizing film 18 is disposed in a position that comes into contact with the transparent support 12, intended effects are obtained.

### EXAMPLES

Hereinafter, the present invention will be more specifically described based on examples. The materials, the amount and proportion thereof used, the details and procedure of processing, and the like can be appropriately changed within a scope that does not depart from the gist of the present invention. Therefore, the scope of the present invention is not limited to the following examples.

### Example 1

### Preparation of Transparent Support A

The following composition was put into a mixing tank and stirred while being heated such that the respective components were dissolved, thereby preparing a cellulose acylate solution A.

Composition of cellulose acylate solution A

| | |
|---|---|
| Cellulose acetate with a degree of | 100 parts by mass |
| substitution of 2.86 | |
| Triphenyl phosphate (plasticizer) | 7.8 parts by mass |
| Biphenyl diphenyl phosphate | 3.9 parts by mass |
| (plasticizer) | |
| Methylene chloride (first solvent) | 300 parts by mass |
| Methanol (second solvent) | 54 parts by mass |
| 1-Butanol | 11 parts by mass |

The following composition was put into another mixing tank and stirred while being heated such that the respective components were dissolved, thereby preparing an additive solution B.

Composition of additive solution B

| | |
|---|---|
| The following compound B1 (Re reducing | 40 parts by mass |
| agent) | |
| The following compound B2 (wavelength | 4 parts by mass |
| dispersion control agent) | |
| Methylene chloride (first solvent) | 80 parts by mass |
| Methanol (second solvent) | 20 parts by mass |

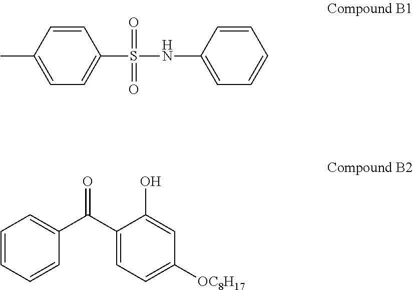

<Preparation of Cellulose Acetate Transparent Support>

477 parts by mass of the cellulose acylate solution A and 40 parts by mass of the additive solution B were mixed together and thoroughly stirred, thereby preparing a dope. From a casting outlet, the dope was cast onto a drum cooled to 0° C. In a state in which the solvent content was 70% by mass, the film was peeled off, and both ends of the film in the width direction were fixed to a pin tenter (a pin tenter described in FIG. 3 of JP 4-1009 A). Thereafter, in a state in which the solvent content was 3% by mass to 5% by mass, the film was dried while the interval thereof was being maintained such that a stretch ratio thereof in the horizontal direction (direction perpendicular to the machine direction) became 3%. The film was then transported between rolls of a thermal processing apparatus and dried, thereby preparing a cellulose acetate protective film having a thickness of 60 lam (transparent support A). The transparent support A did not contain an ultraviolet absorber, and Re (550) and Rth (550) thereof were 0 nm and 12.3 nm, respectively.

<<Alkaline Saponification Processing>>

The cellulose acetate transparent support A was passed through an induction heating roll at a temperature of 60° C. to increase the film surface temperature to 40° C., and then, one surface of the film was coated with an alkaline solution that had the following composition by using a bar coater at a coating amount of 14 ml/m². The film was then heated at 110° C. and transported for 10 seconds under a steam-type far infrared heater manufactured by Noritake, Co, Limited. Subsequently, the film was coated with pure water at 3 ml/m² by using the same bar coater. Thereafter, the film was washed three times with water by using a fountain coater, drained three times by using an air knife, and then dried by being transported for 10 seconds in a drying zone at 70° C. In this way, a cellulose acetate transparent support A having undergone alkaline saponification processing was prepared.

Composition of alkaline solution (part by mass)

| | |
|---|---|
| Potassium hydroxide | 4.7 parts by mass |
| Water | 15.8 parts by mass |
| Isopropanol | 63.7 parts by mass |
| Surfactant | |
| SF-1: C₁₄H₂₉O(CH₂CH₂O)₂₀H | 1.0 part by mass |
| Propylene glycol | 14.8 parts by mass |

<Preparation of Transparent Support with Running Alignment Film>

The saponification-processed surface of the transparent support prepared as above was continuously coated with coating liquid for forming an alignment film having the following composition by using a #8 wire bar. Then, the support was dried for 60 seconds by hot air at 60° C. and further dried for 120 seconds by hot air at 100° C., thereby forming an alignment film.

Composition of coating liquid for forming alignment film

| | |
|---|---|
| Polymer material for alignment film | 4.0 parts by mass |
| (PVA103, polyvinyl alcohol, | |
| manufactured by KURARAY CO., LTD.) | |
| Methanol | 36 parts by mass |
| Water | 60 parts by mass |

<Preparation of Optically Anisotropic Layer A>

On the surface of the alignment film prepared as above, rubbing processing was continuously performed in a direction inclining by an angle of 45° toward the left-hand side with respect to the longitudinal direction of the transparent support A. The rubbing-processed surface was coated with the following coating liquid for an optically anisotropic layer by using a bar coater. Thereafter, the resultant was heated and aged for 90 seconds at a film surface temperature of 115° C., and then cooled to 80° C. Thereafter, the resultant was irradiated with ultraviolet rays by using an air-cooled metal halide lamp (manufactured by EYE GRAPHICS Co., Ltd.) at 20 mW/cm² in the air in an irradiation amount of 200 mJ/cm² so as to fix the alignment state thereof, thereby forming an optically anisotropic layer A. The slow axis of the formed optically anisotropic layer A was orthogonal to the rubbing direction, and discotic liquid crystal was vertically aligned in the optically anisotropic layer A. The values of retardation of the optically anisotropic layer A at wavelengths of 450 nm, 550 nm, and 650 nm were as follows. The thickness of the optically anisotropic layer A was 2.5 μm.

ReA (450): 273 nm

ReA (550): 250 nm

ReA (650): 240 nm

ReA (450)/ReA (650): 1.14

Composition of coating liquid for optically anisotropic layer
(Composition for forming optically anisotropic layer A1)

| | |
|---|---|
| Discotic liquid crystal E-1 | 80 parts by mass |
| Discotic liquid crystal 2 | 20 parts by mass |
| Alignment agent for alignment film | 0.55 parts by mass |
| interface 1 | |
| Alignment agent for alignment film | 0.05 parts by mass |
| interface 2 | |
| Fluorine-containing compound | 0.1 parts by mass |
| Modified trimethylolpropane | 10 parts by mass |
| triacrylate | |
| Photopolymerization initiator | 3.0 parts by mass |
| (Irgacure 907, manufactured by Ciba | |
| Specialty Chemicals, Inc.) | |
| Interlayer alignment agent | 0.6 parts by mass |
| Methyl ethyl ketone | 180 parts by mass |
| Cyclohexanone | 20 parts by mass |

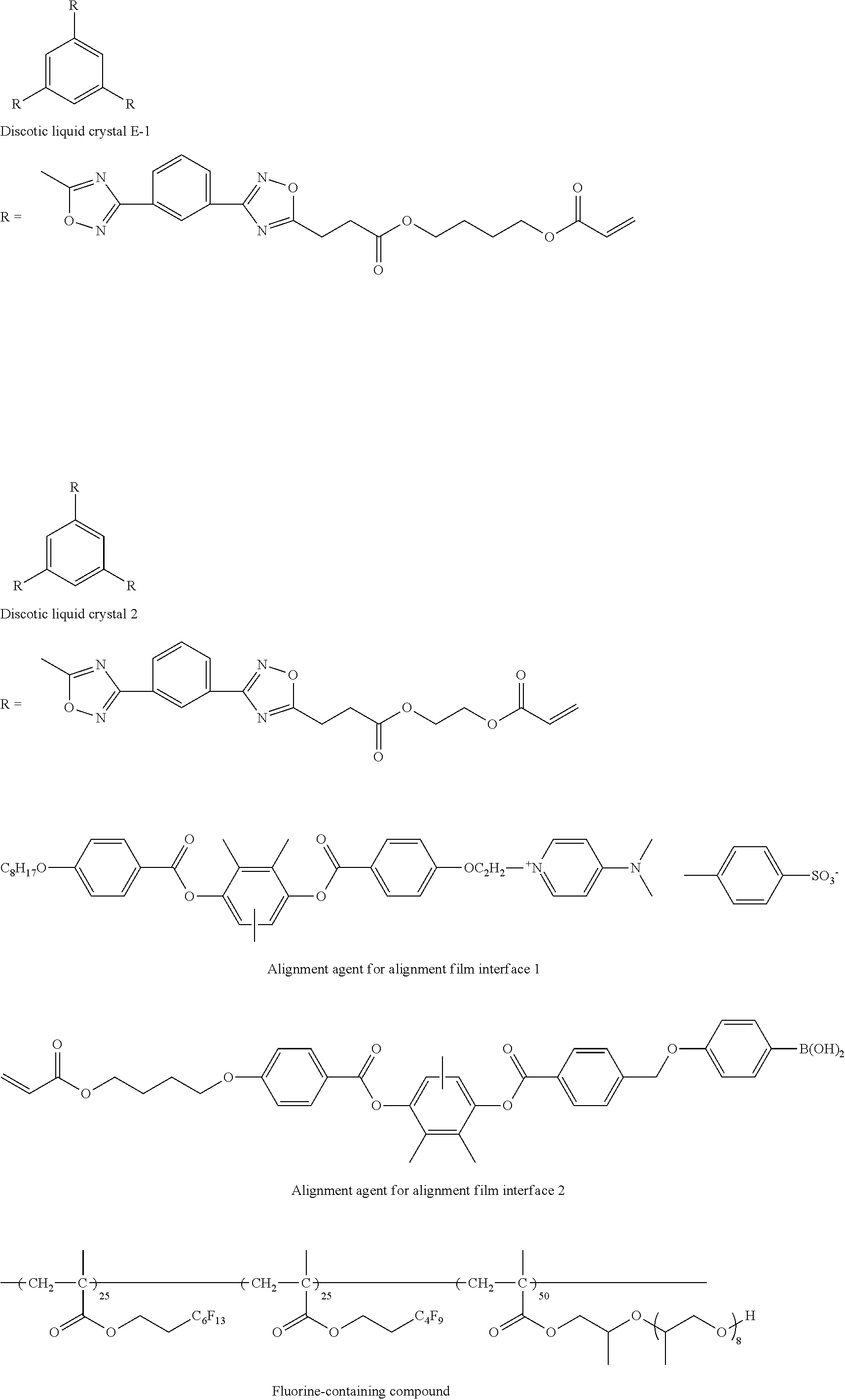

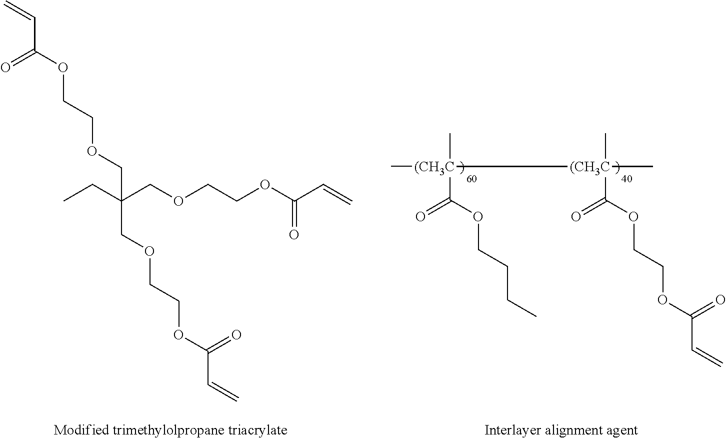

<Preparation of Optically Anisotropic Layer B>

Rubbing processing was continuously performed on the surface of the optically anisotropic layer A, in a direction orthogonal to the slow axis of the optically anisotropic layer A. The rubbing-processed surface was coated with the following coating liquid for an optically anisotropic layer by using a bar coater. Thereafter, the resultant was heated and aged for 60 seconds at a film surface temperature of 60° C., and then irradiated with ultraviolet rays by using an air-cooled metal halide lamp (manufactured by EYE GRAPHICS Co., Ltd.) at 20 mW/cm² in the air so as to fix the alignment state thereof, thereby forming an optically anisotropic layer B. The slow axis of the formed optically anisotropic layer B was parallel to the rubbing direction, and rod-like liquid crystal was horizontally aligned in the optically anisotropic layer B. The values of retardation of the optically anisotropic layer B at wavelengths of 450 nm, 550 nm, and 650 nm were as follows. The thickness of the optically anisotropic layer B was 1.0 μm.

ReB (450): 141 nm

ReB (550): 125 nm

ReB (650): 120 nm

ReA (450)/ReB (650): 1.18

Between the ReA (550) of the optically anisotropic layer A and the ReB (550) of the optically anisotropic layer B, a relationship of ReA (550)>ReB (550) is established, and accordingly, the relationship of Expression (3) is satisfied.

Composition of coating liquid for optically anisotropic layer
(composition for forming optically anisotropic layer B)

| | |
|---|---|
| Rod-like liquid crystal compound 1 | 90 parts by mass |
| Rod-like liquid crystal compound 2 | 10 parts by mass |
| Polymerization initiator | 3.0 parts by mass |
| (Irgacure 907, manufactured by Ciba | |
| Specialty Chemicals, Inc.) | |
| Sensitizer (Kayacure-DETX, manufactured | 1.0 part by mass |
| by Nippon Kayaku Co., Ltd.) | |
| Fluorine-containing compound | 0.5 parts by mass |
| Methyl ethyl ketone | 400 parts by mass |

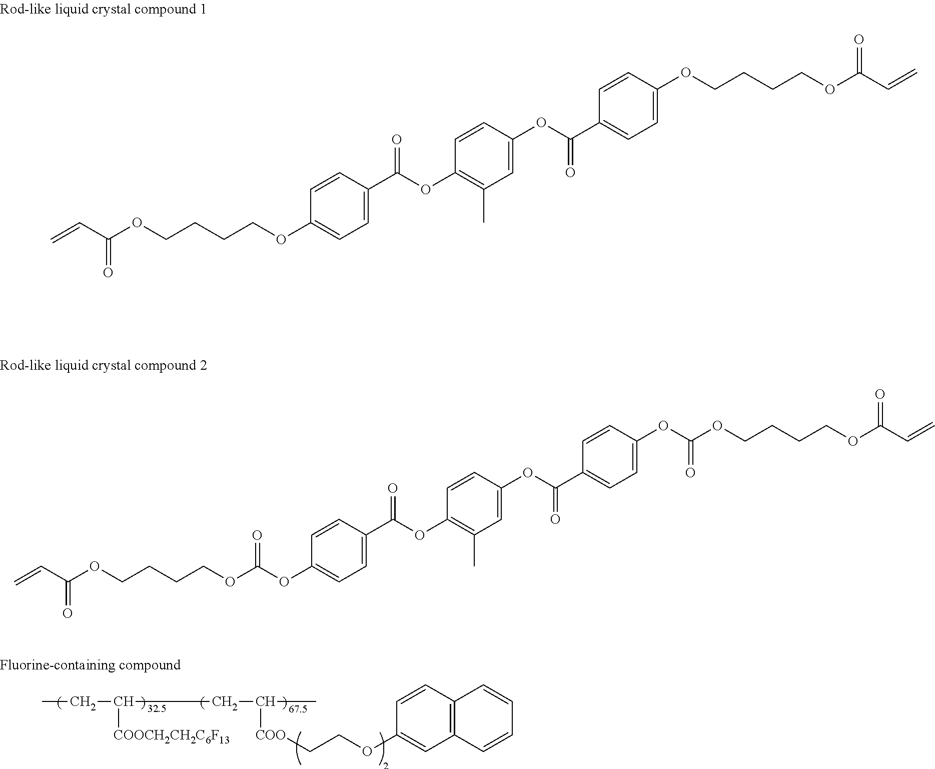

<Preparation of Circularly Polarizing Plate>

As a polarizing plate, a polarizing plate with a polarizing film having a thickness of 20 μm of which only one surface was protected with triacetyl cellulose (having a thickness of 40 μm) was used. The unprotected surface (polarizing film composed of stretched polyvinyl alcohol) of the polarizing plate was stuck on the cellulose acetate transparent support (the surface of the cellulose acetate transparent support at the side opposite to the side on which the optically anisotropic layer A was disposed) by using an optically isotropic adhesive, thereby preparing a circularly polarizing plate. At this time, an angle of 45° was formed between the absorption axis of the polarizing film and the slow axis of the optically anisotropic layer A, and the slow axis of the optically anisotropic layer A was orthogonal to the slow axis of the optically anisotropic layer B.

<Measurement of Haze Value>

The total haze value (H) of the optical laminate including the transparent support, the optically anisotropic layer A, and the optically anisotropic layer B manufactured as above was measured based on JIS-K7136 by using a haze meter NDH 2000 manufactured by NIPPON DENSHOKU INDUSTRIES Co., LTD.

### Example 2

A circularly polarizing plate was manufactured according to the same procedure as in Example 1, except that the irradiation amount of ultraviolet rays was changed to 150 mJ/cm² from 200 mJ/cm².

ReA (450), ReA (550), and ReA (650) which were values of retardation of the optically anisotropic layer A measured at wavelengths of 450 nm, 550 nm, and 650 nm, and ReB (450), ReB (550), and ReB (650) which were values of retardation of the optically anisotropic layer B measured at wavelengths of 450 nm, 550 nm, and 650 nm were the same as in Example 1.

### Example 3

A circularly polarizing plate was manufactured according to the same procedure as in Example 1, except that the irradiation amount of ultraviolet rays was changed to 300 mJ/cm² from 200 mJ/cm².

ReA (450), ReA (550), and ReA (650) which were values of retardation of the optically anisotropic layer A measured at wavelengths of 450 nm, 550 nm, and 650 nm, and ReB (450), ReB (550), and ReB (650) which were values of retardation of the optically anisotropic layer B measured at wavelengths of 450 nm, 550 nm, and 650 nm were the same as in Example 1.

### Example 4

A circularly polarizing plate was manufactured according to the same procedure as in Example 1, except that the manufacturing procedure of the optically anisotropic layer A was changed to the following procedure, and the thickness of the optically anisotropic layer B was changed to 5.0 μm from 1.0 μm.

(Preparation of Optically Anisotropic Layer A)

On the surface of the alignment film prepared as above, rubbing processing was continuously performed in a direction inclining by an angle of 45° toward the left-hand side with respect to the longitudinal direction of the transparent support. The rubbing-processed surface was coated with the following coating liquid for an optically anisotropic layer by using a bar coater. Thereafter, the resultant was heated and aged for 90 seconds at a film surface temperature of 130° C., and then cooled to 80° C. Thereafter, the resultant was irradiated with ultraviolet rays by using an air-cooled metal halide lamp (manufactured by EYE GRAPHICS Co., Ltd.) at 20 mW/cm² in the air in an irradiation amount of 200 mJ/cm² so as to fix the alignment state thereof, thereby forming an optically anisotropic layer A. The slow axis direction of the formed optically anisotropic layer A was parallel to the rubbing direction, and the discotic liquid compound was vertically aligned in the optically anisotropic layer A. The values of retardation of the optically anisotropic layer A at wavelengths of 450 nm, 550 nm, and 650 nm were as follows. The thickness of the optically anisotropic layer A was 2.5 μm.

ReA (450): 476 nm

ReA (550): 400 nm

ReA (650): 376 nm

ReA (450)/ReA (650): 1.27

ReB (450), ReB (550), and ReB (650) which were values of retardation of the optically anisotropic layer B measured at wavelengths of 450 nm, 550 nm, and 650 nm were as follows.

ReB (450): 610 nm

ReB (550): 540 nm

ReB (650): 518 nm

ReB (450)/ReB (650): 1.18

Between the ReA (550) of the optically anisotropic layer A and the ReB (550) of the optically anisotropic layer B, a relationship of ReB (550)>and ReA (550) is established, and accordingly, the relationship of Expression (2) is satisfied.

Composition of coating liquid for optically anisotropic layer
(Composition for forming optically anisotropic layer A2)

| | |
|---|---|
| Discotic liquid crystal compound | 90 parts by mass |
| Fluorine-containing compound | 0.1 parts by mass |
| Vertical alignment agent | 0.5 parts by mass |
| Modified trimethylolpropane triacrylate | 5 parts by mass |
| Photopolymerization initiator | 3.0 parts by mass |
| (Irgacure 907, manufactured by Ciba | |
| Specialty Chemicals, Inc.) | |
| Sensitizer (Kayacure-DETX, manufactured | 1.0 part by mass |
| by Nippon Kayaku Co., Ltd.) | |
| Interlayer alignment agent | 0.6 part by mass |
| Methyl ethyl ketone | 180 parts by mass |
| Cyclohexanone | 20 parts by mass |

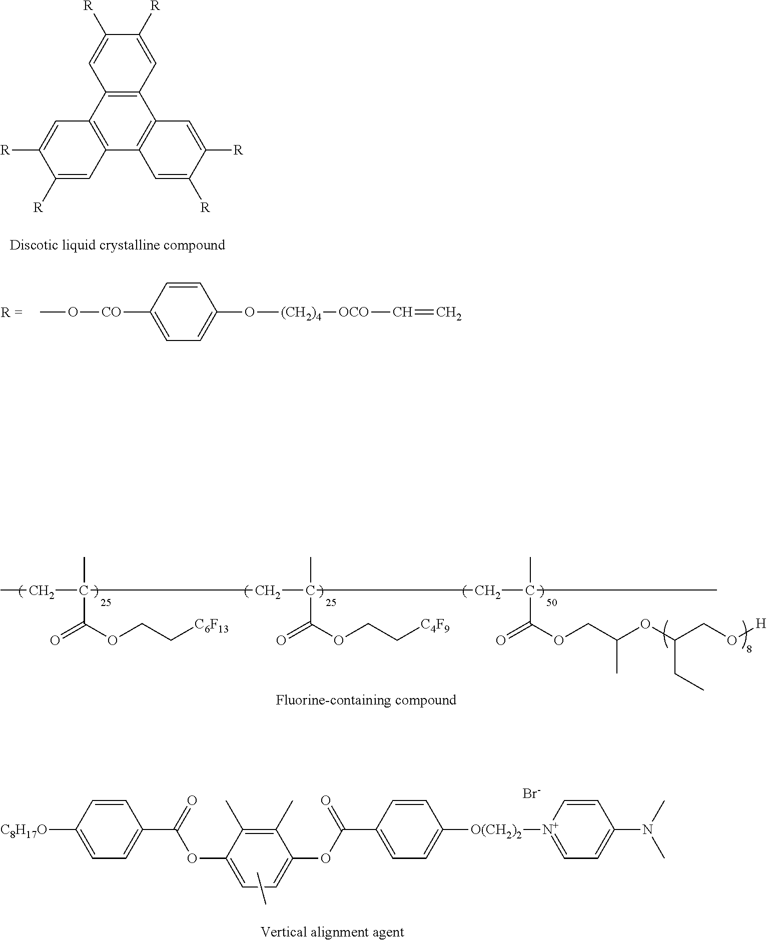

### Comparative Example 1

A circularly polarizing plate was manufactured according to the same procedure as in Example 1, except that the irradiation amount of ultraviolet rays was changed to 700 mJ/cm² from 200 mJ/cm².

### Comparative Example 2

A circularly polarizing plate was manufactured according to the same procedure as in Example 1, except that the irradiation amount of ultraviolet rays was changed to 1,000 mJ/cm² from 200 mJ/cm².

### Comparative Example 3

A circularly polarizing plate was manufactured according to the same procedure as in Example 1, except that the irradiation amount of ultraviolet rays was changed to 400 mJ/cm² from 200 mJ/cm².

### Comparative Example 4

A circularly polarizing plate was manufactured according to the same procedure as in Example 1, except that the irradiation amount of ultraviolet rays was changed to 50 mJ/cm² from 200 mJ/cm².

<Evaluation of Display Performance>

The organic EL panel-mounted GALAXY SII manufactured by SAMSUNG was disassembled, and a circularly polarizing plate was peeled off. Thereafter, each of the circularly polarizing plates manufactured in the aforementioned examples and comparative examples was stuck on the apparatus while preventing air from entering therebetween, thereby preparing display apparatuses. The prepared organic EL display apparatuses were evaluated in terms of visibility in a bright room having illuminance of 200 lux.

Each of the display apparatuses was caused to display an image (black display) and illuminated with a fluorescent light from the front thereof and at a polar angle of 45°. At this time, the level of image sharpness and the degree of white turbidity were observed and evaluated based on the following criteria. The results are summarized in Table 1. For practical use, the image sharpness and the white turbidity need to be level 4 or 5.

5: The white turbidity is not visually recognized at all, and the image is sharp.

4: Although the white turbidity is not visually recognized, black tightness is a little poor. The image is sharp.

3: Partial slight white turbidity is visually recognized, and a portion of the image is slightly unsharp.

2: Slight white turbidity is visually recognized throughout the display, and the image is slightly unsharp.

1: Obvious white turbidity is visually recognized throughout the display, and the image is unsharp.

In Table 1, “thickness of optical laminate” represents the total value of the thickness of the transparent support, the thickness of the optically anisotropic layer A, and the thickness of the optically anisotropic layer B.

In Table 1, “DLC 1” in the column of “optically anisotropic layer A” means that the optically anisotropic layer was formed by using the aforementioned composition for forming the optically anisotropic layer Al, and “DLC 2” means that the optically anisotropic layer was formed by using the aforementioned composition for forming the optically anisotropic layer A2.

TABLE 1

| | | Irradiation | Thickness of | | |
|---|---|---|---|---|---|
| | Optically | amount of | optical | | |
| | anisotropic layer A | ultraviolet rays | laminate | Haze (%) | Visibility |
| Example 1 | DLC 1 | 200 mJ/cm² | 63.5 μm | 0.31 | 5 |
| Example 2 | DLC 1 | 150 mJ/cm² | 63.5 μm | 0.29 | 5 |
| Example 3 | DLC 1 | 300 mJ/cm² | 63.5 μm | 0.42 | 4 |
| Example 4 | DLC 2 | 200 mJ/cm² | 67.5 μm | 0.32 | 5 |
| Comparative | DLC 1 | 700 mJ/cm² | 63.5 μm | 0.74 | 2 |
| example 1 | | | | | |
| Comparative | DLC 1 | 1,000 mJ/cm² | 63.5 μm | 0.99 | 1 |
| example 2 | | | | | |
| Comparative | DLC 1 | 400 mJ/cm² | 63.5 μm | 0.51 | 3 |
| example 3 | | | | | |

| | | | | |
|---|---|---|---|---|
| Comparative | DLC 1 | 50 mJ/cm² | 63.5 μm | Rubbing defect resulting |
| example 4 | | | | from surface tackiness |

From the above table, it was confirmed that in Examples 1 to 4 in which the irradiation amount of the ultraviolet irradiation processing for forming the optically anisotropic layer A was within a predetermined range, circularly polarizing plates having excellent visibility were obtained. Particularly, it was confirmed that when the haze value was equal to or less than 0.40%, the visibility was better.

In contrast, it was confirmed that in Comparative examples 1 to 4 in which the irradiation amount of the ultraviolet irradiation processing was not within a predetermined range, visibility was poor, or the rubbing defect occurred.

What is claimed is:

1. A circularly polarizing plate comprising:
an optical laminate; and
a polarizing film,
wherein the optical laminate has a transparent support, an optically anisotropic layer A, and an optically anisotropic layer B that are laminated on each other in this order,
the optically anisotropic layer A is formed of a composition containing a discotic liquid crystal compound having a polymerizable group,
the optically anisotropic layer B is formed of a composition containing a rod-like liquid crystal compound having a polymerizable group,
ReA (450), ReA (550), and ReA (650) which are values of retardation of the optically anisotropic layer A measured at wavelengths of 450 nm, 550 nm, and 650 nm, and ReB (450), ReB (550), and ReB (650) which are values of retardation of the optically anisotropic layer B measured at wavelengths of 450 nm, 550 nm, and 650 nm satisfy the following Expression (1),
when ReB (550)>ReA (550), Expression (2) is satisfied,
when ReA (550)>ReB (550), Expression (3) is satisfied, and
a haze value X of the optical laminate satisfies the following Expression (4):
100 nm≦|ReB(550)−ReA(550)|≦180 nm Expression (1)
ReB(450)/ReB(650)<ReA(450)/ReA(650) Expression (2)
ReA(450)/ReA(650)<ReB(450)/ReB(650) Expression (3)
and
X<0.50% Expression (4)

2. The circularly polarizing plate according to claim 1,
wherein an angle formed between either a slow axis of the optically anisotropic layer A or a slow axis of the optically anisotropic layer B and an absorption axis of the polarizing film is 45°, and the slow axis of the optically anisotropic layer A is orthogonal to the slow axis of the optically anisotropic layer B.

3. A method for manufacturing the circular polarizing plate according to claim 1, comprising at least a step of forming the optically anisotropic layer A by performing ultraviolet irradiation processing on the discotic liquid crystal compound having a polymerizable group,
wherein an irradiation amount of the ultraviolet irradiation processing is equal to or greater than 100 mJ/cm² and less than 400 mJ/cm².

4. An optical laminate comprising:
a transparent support, an optically anisotropic layer A, and an optically anisotropic layer B that are laminated on each other in this order,
wherein the optically anisotropic layer A is formed of a composition containing a discotic liquid crystal compound having a polymerizable group,
the optically anisotropic layer B is formed of a composition containing a rod-like liquid crystal compound having a polymerizable group,
ReA (450), ReA (550), and ReA (650) which are values of retardation of the optically anisotropic layer A measured at wavelengths of 450 nm, 550 nm, and 650 nm, and ReB (450), ReB (550), and ReB (650) which are values of retardation of the optically anisotropic layer B measured at wavelengths of 450 nm, 550 nm, and 650 nm satisfy the following Expression (1),
when ReB (550)>ReA (550), Expression (2) is satisfied,
when ReA (550)>ReB (550), Expression (3) is satisfied, and
a haze value X of the optical laminate satisfies the following Expression (4):
100 nm≦|ReB(550)−ReA(550)|≦180 nm Expression (1)
ReB(450)/ReB(650)<ReA(450)/ReA(650) Expression (2)
ReA(450)/ReA(650)<ReB(450)/ReB(650) Expression (3)
and
X<0.50% Expression (4)

5. The optical laminate according to claim 4,
wherein a slow axis of the optically anisotropic layer A is orthogonal to a slow axis of the optically anisotropic layer B.

6. The circularly polarizing plate according to claim 1, wherein the optically anisotropic layer A is in direct contact with the optically anisotropic layer B.

7. The optical laminate according to claim 4, wherein the optically anisotropic layer A is in direct contact with the optically anisotropic layer B.

8. A method for manufacturing the circularly polarizing plate according to claim 2, comprising at least a step of forming the optically anisotropic layer A by performing ultraviolet irradiation processing on the discotic liquid crystal compound having a polymerizable group,
wherein an irradiation amount of the ultraviolet irradiation processing is equal to or greater than 100 mJ/cm² and less than 400 mJ/cm².
